(19) United States
(12) Patent Application Publication
(10) Pub. No.: US 2004/0236634 A1
(43) Pub. Date: Nov. 25, 2004

(54) Method for acquiring a given product through a public infomation network, such as the internet

(76) Inventor: Jari Ruuttu, Billnas (FI)

Correspondence Address: YOUNG & THOMPSON, 745 SOUTH 23RD STREET, 2ND FLOOR, ARLINGTON, VA, 22202, US

(21) Appl. No.: 10/488,961

(22) PCT Filed: Sep. 12, 2002
(86) PCT No.: PCT/FI02/00732

(30) Foreign Application Priority Data
Sep. 14, 2001 (FI) 20011814

(51) Int. Cl. G06F 17/60

(52) U.S. Cl. 705/26

(57) ABSTRACT

The invention relates to a method for acquiring a given product over a public network, such as the Internet. The method allows the customer using his computer to influence the appearance of the product, such as the surface pattern, colour, text, logos, figures etc., and then the customer orders the product he has designed from the manufacturing company. For the design of the product, the customer acquires an application program and contacts the product and service provider, selects the product he wants and designs the appearance of the product using his own computer.

This invention relates to a method for acquiring a given product over a public data network, such as the Internet, in which the customer is given the opportunity to influence the appearance of the product, such as the surface pattern, colour, text, logos, figures etc. by means of a computer, after which the customer orders the product he has designed from the manufacturer of the product.

Nowadays customers may visit various market sites on the Internet, study and look at different products, select the most appropriate among these and compare prices and other conditions of delivery.

Consequently, the customer does not necessarily buy the products he wants at one single site, but instead, he may go shopping at tens or even hundreds of different market sites.

Customers also wish to influence the appearance of a product, causing numerous problems, to which the invention provides a solution.

Solutions available so far, to which we shall revert later, have attempted to resolve the problem either by making an entire design program directed to a single specific product available to the customer e.g. over the Internet, Citizen cora ep 0990 962, Ruuttu et al FI 19992110, or the method of the Nokia company, in which the customer loads down a design program from the company's homepage to allow the aspects of the company's products to be designed.

This is actually the problem. It is not conceivable for the customer to load down a design program each time in order to be able to design the appearance of a specific product of this particular company, given the hundreds of thousands of companies selling products and tens of manufacturing companies, e.g. the mobile phone manufacturers (Nokia, Ericsson, Sony, Motorola, Samsung, Siemens, Panasonic etc.)

Among these companies, only one provides a program allowing the customer to design the appearance of the product and to subsequently load down the program in his personal computer from the company's homepage over the Internet.

When, in the future, other companies start offering the same service, the customer will be in a situation where he will have to load down the design program of the manufacturing company in his own personal computer. One single company having tens of programs, and some thousand programs considering the other product lines, this means that the customer ought to load down hundreds of programs in his own personal computer.

None of the patents known or filed so far obviously provides a working overall solution to this problem, i.e. that the customer has to load down the program each time he wishes to design the appearance of a product. Besides, products are renewed at an increasing rate, implying that a new program should be loaded down each time. A customer does not even always know whether the product is still available at the moment he has design its appearance. In other words, the customer does not know whether he will receive the product he has designed.

Should the production technology change or the program be altered for one reason or the other, at the launching of a new model of the product, for instance, the entire program must be renewed, because the design program and the product data (3-dimensional graphics) are in the same program as the one the customer loads down into his own personal computer from the homepage of the manufacturing company.

### Design of the Appearance of a Product

The new method takes account of the actual design mode, “keyboard”, which is the conventional way of giving a cursor command on an image seen on the display, “text”, where the customer gives the command by writing, and “sound”, which, on principle, is the same as the text, except that the command is given by sound and requires an adequate sound identifying apparatus or program.

Before studying the design element proper, the overall operation of the new invention is described.

Even if the examples relate to a given product, a mobile phone shell, and the Patent Application deals with telecommunication products and electronic products, the functionality of the new method can be described on this restricted scale.

The new method is primarily intended for operation in a broadband network, which has high data transmission capacity.

However, a variant is described, which operates in rapid fixed modem operation, such as ISDN, ASDL etc. Yet a modem connection is far slower than direct connection in a broadband network.

The method of the invention is characterised in the customer acquiring an application program for the design of the product and contacting the product and service provider, selecting the product he desires and designing the appearance of the product by means of his own computer.

There are two versions of the method: A, intended for transmission speeds in a broadband network, and B, having lower transmission speeds.

As defined in the claims, both the versions allow design once the customer has been connected over the Internet to the service provider, or the customer may freely design the product even without his personal computer being connected to the network.

Various embodiments of the invention are described in the claims of the set of claims.

The essential feature of the new method is that the design process can be performed only over a connection with the service provider, his server or homepage, for instance.

The entire processing and all the software are in the computer of the service provider, and no program is loaded down from the server to the customer's personal computer, but instead, the customer controls the design process in its totality from his own computer.

The new method differs from known methods in that the customer does not have to load down any program, and having selected the product, he is free to start designing its appearance.

All the processes take place in real time. e.g. the offers, conditions of delivery and the design program, and this avoids problems caused by downloading of design programs in conventional methods; in a situation where the customer postpones the design of the product by say, 3 months instead of doing it at once, he can no longer be sure of the availability of the product or of the production technology remaining the same. The new method also makes it easier to compare the programs of different manufacturers.

### Extent of the New Method

The purpose of the new method is to facilitate trade between customers and manufacturers/sellers over the Internet.

This requires an operating principle different from current principles.

1. Operation advantageously takes place in a broadband network having extremely high transmission speeds, 2 Mb/s, yet the invention also covers the use of modem connections ISDN, ASDL etc.

2. The main principle is that the entire design process takes place in the computer of the service provider. The customer gives the commands from his own personal computer, but the process itself takes place in the computer of the service provider, which contains all the design programs, image files, image-processing programs, 3-dimensional data, 3-dimensional graphics and operating system of the design program. The customer sees the design process and influences it as though the programs were in his own personal computer. In this respect, the use of emulators metaframe/citrix type offers one option. In that case, all of the program optic is in the server. Later on, a product data program storing the viewing mode will be created for the customer.

If the customer interrupts his work, the work done up to that point will consequently remain in the memory of the customer's personal computer or in the memory of the computer of the service provider, and when the customer is reconnected to the Internet address of the service provider, he may go on from where he stopped.

Since the method is a real-time method, it may also be interactive. Interactivity signifies interaction between the customer and the service provider, which will be a crucial branch in the future.

The service provider may build up the user profile: age, family conditions, domicile, products purchased and prices, brand fidelity etc., allowing him to make the customer new offers later on.

In this context, the optimal environment of use has been described, that is a realtime method for acquiring and designing the appearance of a specific product, the process taking place only when the customer has contacted the Internet address of the service provider and has been connected over this to the server. The method is characterised by the customer using the computer of the service provider at his own personal computer, and no program is being transferred to the customer's personal computer.

The B version of the new method for acquiring a given product and for designing its appearance comprises, item 2, a method that operates in the normal network over a modem communication ISDN, ASDL, etc., the transmission speed being far slower than in direct Internet communication.

The term application program is used to denote the plurality of data systems and application programs controlling the operation of the server in the customer's personal computer. The application program comprises a fixed data transmission system, comprising among other things:

design programs

graphic control programs

image processing and editing programs

various material files

letters and numbers

different fonts

Accordingly, the data and related applications transferred between the server of the service provider and the customer's computer are called a product data program, which is a variable data transmission system comprising among other things:

company data

instructions for use

3-dimensional product data

product files

control data and codes indicating the programs in use

billing and delivery information

The CD disc included in the application program is acquired from a shop or a kiosk, for instance. The application program and the product data program of the product manufacturer are fully compatible. The method of the invention offers excellent service reliability and quality. All the customer has to do is to acquire the product data program over the Internet, which is very quickly done, since it is not necessary to load down an entire application program from the Internet.

The use of the Internet as a means of communication for data transmission and business between people, people and companies, and companies, respectively, pertains to prior art.

Compared to printed information, for instance, the Internet as a data transmission means is superior at least in one respect: the information provider may change the content in real time, such as, for instance, the model, dimensions etc. of the mobile phone. The new information will always be available to the customer in real time 24 hours a day. This is the “variable” information.

Files, i.e. information are also available and usable in fixed form, such CD-ROM discs and DVD discs, or on a microdisc. Large files are usually precisely in CD form, e.g. video games, Playstation or image processing programs and 3-dimensional draw programs.

The customer may acquire these “fixed” recordings from shops, directly from the product manufacturer, or he may order the content over the Internet and bum the CD disc himself.

The method of the invention, which allows the customer to freely design the appearance of his product, select the manufacturing method and material, devise the 3-dimensional shape, in other words, design the product he desires, combines two data transmission means, e.g. the Internet and a CD-ROM-disc.

The use of one single information system involves the following drawback: as the customer may freely design the appearance, i.e. the surfaces of the products he has chosen, devise the 3-dimensional, i.e. physical 3-dimensional dimensions of the products, create entities, such as the outside of an entire house or all the furnishings of a house, or design part of the interior of a ship or the whole interior of a ship, this leads to a situation where there are many different products and product groups, and also mutually independent product manufacturers, resulting in a very heavy program.

With the new method, data transmission has been divided into two parts, as defined in claims 2 and 3, so that the heavy part, i.e. the actual programs and different files are in the “fixed” data transmission system, the method not being bound to any particular product or group of products. The customer controls the programs installed in the server of the service provider by means of data taken into use and transmitted by the data transmission system.

The customer may order the file from the manufacturing company, purchase it in a shop or order e.g. a CD-ROM disc over the Internet, or he may himself load down the file on a CD over the Internet.

The new method has the essential feature of the customer not needing to load down the file repeatedly each time. This means that a “fixed” data transmission system, e.g. on a CD, contains all the essential data, except for the varying data, e.g. 3-dimensional shapes and company data (claim 3). Consequently, data transmission is rapid, because only varying files are transferred.

Hence the method has the essential feature of transferring a minimum of information, the very file that can be utilised again or used in other products as well.

This means that only the files defined in claims 1-3 need to be transferred, i.e. about 10% of the total number of files. This yields security, rapidity and a wide range of products.

The customer/user may act on the “fixed” data transmission system. i.e. he may select the complete system or just one segment. In that case, the “fixed” data transmission system will include only the programs, files, relating to the particular line of business in question, but not to other lines of business. The customer may also select more than one line of business. The customer may thus purchase a finished CD in a shop or he may himself design a “fixed” data transmission system and pass orders over the Internet to the company providing the service.

A shipbuilding yard making cruisers is an example of the operability and flexibility of the innovation in the creation of extremely large entities. Contrary to the preceding cases, where the customer wanted to limit the range of a “fixed” data transmission system, it is presently desirable to enlarge and position the described “fixed” data transmission system as follows:

Luxury cruisers typically have individual furnishings and material choices, naturally also with regard to individual products, such as lamps, tables, furniture in general, guide boards, etc.

In other words, a ship is an architectural entity created by one or more architects, and the building of a ship requires numerous subcontractors, who usually also perform the mounting of the products they have manufactured.

Then the customer, i.e. a shipbuilding company that manufactures a ship, may tailor a “fixed” data transmission system, comprising e.g. detailed dimensional drawings of the different ship segments, areas, including windows, electric and heating, plumbing and air conditioning, with each portion of the ship divided into encoded individual sectors, for instance.

As mentioned above, hundreds of subcontractors are involved in the furnishing and building of a ship. The shipbuilding company provides the “fixed” data transmission system, or else indicates where it can be purchased. The system is encoded sector-wise, and it does not include any product, design or material information. The “variable” data transmission system, which always operates over the Internet, includes the code sectors and the company's own codes, a password, for instance. Then a subcontractor, who already has a “fixed” data transmission system, receives the product-specific information he needs from the “variable” data transmission system, such as 3-dimensional files, materials, attachments and naturally control data, i.e. the program giving access to the basic program on which the customer cannot act.

This allows the whole process to be accurately monitored. A given subcontractor gets access to a product data program with a code he has received.

Consequently, there is no need to give all the subcontractors access to the entire database, which would imply a high security risk for the shipbuilding company.

Since the architect/designer belongs to the group who definitely influences the furnishings of the ship together with the shipbuilding company, he has the opportunity to act directly on precisely the program/file containing variable factors, such as 3-dimensional shapes, surfaces and other product files.

This allows the architect/designer to design all the surfaces, 3-dimensional shapes, the design in its totality, including all details, using the same complete basic program, to transfer finished files equipped with the subcontractor's code to the product data program, from where the subcontractor fetches the product-specific data over the Internet.

### General

Since the manufacturer/supplier/seller of the product may vary in different lines of production, there is an Internet address. e.g. IT-WORLD, Internet WORLD, giving central access to the customer for all the information he needs.

The customer/user may naturally use the basic program in the same way as any image editing program, such as HP Photosmart, Epson Adobe Photo de Luxe or the like.

The user may prepare images, print out, edit, send or receive images over the Internet by scanning, transfer them from a digital camera, etc. However, in that case, the program cannot be directed to any individual product, such as e.g. a glass or a mobile phone, since this cannot take place until the user has fetched the product data program of the manufacturing company, which contains 3-dimensional data, product files etc.

In other words, the application program does not contain the product data of any product groups, such as a 3-dimensional product program.

### Benefits of a Two-Part Program

Should a single product, such as a glass or a watch, be designed, it would be conceivable to have an integral program, yet loading down the actual design program, not the product data program proper, from the Internet requires an unreasonable amount of time.

By contrast, the new method has taken account of the fact that the customer/user wishes more than one single product, and knowing that there will be thousands of manufacturers and perhaps hundreds of thousands of products in the future, which, besides, change continually, the actual basic program is vainly transferred from the manufacturer to the customer/user. In other words, both the programs are compatible, and once the customer/user has received the basic program, he then only needs to load down the product data program, which contains the 3-dimensional product file and a control code program, which the customer cannot influence if the programs only operate in combination.

The transmission speed of the 3-dimensional product file and the control code program is notably higher than that of the actual basic program.

The product data program contains the company's billing and delivery data and possibly an application program.

### General

In the future, people will be increasingly connected directly to the Internet, and this requires a broadband network.

For the time being, about 10% of users have the opportunity to be connected to a broadband network, and in the future, about 50% of users will presumably have this opportunity.

The new invention and its method have considered how those who do not have any broadband network connection will be able to act nearly with the same efficacy.

The operations essential in the operating system of the new method are presented on the following pages.

Under item 2, all the operations described are exclusively in the service provider's computer, however, requiring a broadband network connection, and under item 3, the operation of the new method with a modem, such as ISDN, ADSL is described.

When the customer's personal computer is directly connected to a broadband network, the period and moment the customer is working have no impact as such, because the customer will pay a monthly fee regardless of the time he spends on the net. A modem connection is charged on a time basis. It is not economical for the customer to use the method of version A directly, because it is very slow and expensive. However, the new method provides a solution to this inconvenience in a way that makes a modem connection almost as efficient as a direct broadband network connection.

Given the notably slower data transmission speed of a modem connection compared to that of direct network connection in a broadband network, version B differs in the following respect.

In real-time method version A, all the programs of the operating system are exclusively in the service provider's computer, and the customer controls the process from his own personal computer. In version B, again, the customer loads over the Internet or otherwise a product data program, which contains the design program of the sector (segment), or designs the design program he desires in the way he finds particularly necessary.

This design program includes an image editing program, because this achieves a method that is nearly optimal in terms of efficiency, allowing the customer to switch freely between the programs of different principals (manufacturers, sellers, service providers), because the slowest (heaviest) part to be transferred via modem connections is already loaded down as a separate process in the customer's personal computer.

Thus the customer only needs to load down company data and 3-dimensional data and/or 3-dimensional graphics of the products.

Hence the customer already has access to the described product data program as a separate process, the program containing a design program and an image-editing program, i.e. the parts causing heaviest transfer. The main functions included in the application program are described below, which, in a real-time method, are located in the service provider's computer, but in present version B, a design program and an image processing program can be transferred as a separate process to the customer's personal computer, i.e. the functions that do not relate to any specific product, but enable operability.

In other respects, version B has the same operation as version A.

### Conclusion

The main purpose was to provide a method allowing a customer to switch rapidly and efficiently between the brands of different manufacturers, to compare quality, prices, etc., while being allowed to design the appearance of the product.

The method has the following structure.

1. The customer has access to an almost unlimited number of design options, the process still being extremely rapid. The customer designs the appearance of his product by passing commands to the service provider's computer, where all the programs, the design system and the operating system CSID are located. This works best in a broadband network.

2. The same as 1, but with a SID product data program and an image-editing program transferred to the customer.

3. The same as 1 and 2, but with the customer allowed to design the appearance of his product when not being connected to the net (Internet).

4. Methods 2 and 3 are intended to operate normally in network connections, ISDN, ASDL modems etc.

5. The process can be controlled:

with keyboard commands

with text commands

with sound commands

### Product Data Program

Image File

This file contains previously made images of e.g. trees, leaves, stones, landscapes, the moon, the see, houses, pyramids, and also payable images, showing e.g. music bands or persons.

Active Image Link

Through this image link, the customer may contact directly e.g. a Hubble telescope, other real-time telescopes, provided that the television set communicates with the personal computer, or his own video or DVD camera or his own digital camera.

Image Editing Program

Using the image-editing program, the customer is free to process the images he has picked from the image file or the active image link.

The image-editing program may operate

with a keyboard command

with a text command

with a sound command

The invention is described below with reference to the drawings, in which

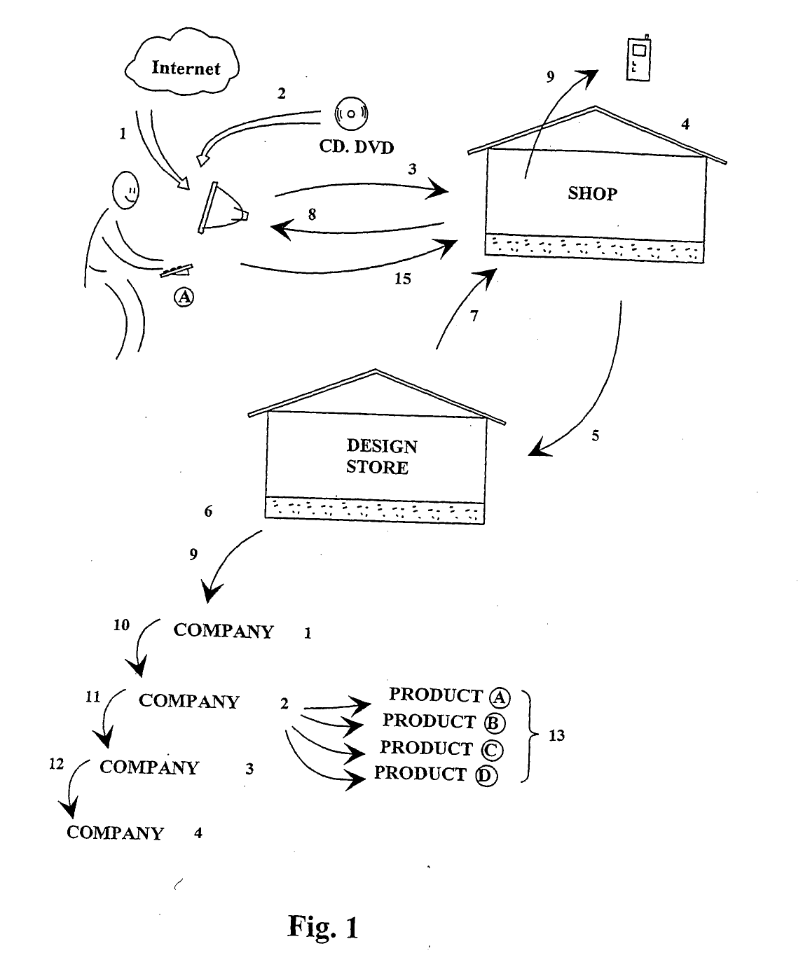

FIG. 1 shows a method, in which

Customer A acquires the first part of the application program over the Internet 1 or e.g. from a shop/manufacturer 2. Then the customer A contacts the homepage/server of the service provider over the Internet 3, selects the product 9 he wishes, e.g. a mobile phone, and indicates that he wishes to design the appearance of the product he desires.

Then the application program of the service provider 4 identifies that the customer A possesses the first part of the application program and that it is correct, i.e. relates explicitly to the product or segment selected by customer A.

Then customer A, who holds the first part of the application program, receives the product data, 3-dimensional data, company data etc. relating to the product. The application program of the service provider automatically gives access to the programs relating to the design of the appearance of the particular product.

The customer has hence loaded 8 the “variable” data into his computer and may now start his design work.

When the customer has designed the appearance of his product, he returns 15 the data over the Internet to the service provider and orders his product.

The service provider 4 may also be connected to more than one service provider 9, 10, 11.

The “shop” may be a special shop of department store type, e.g. a market site specialised in electronics.

The customer is free to scan different products in which he is interested, and when he finds the specific manufacturer and model of an interesting product, e.g. a mobile phone 9, he chooses e.g. “design” in the menu, and then gets access to 3-dimensional data and 3-dimensional graphics. These are located e.g. in a separate server/file, e.g. a design store.

While the customer receives the “variable” data, i.e. company data and product data, part B of the application program gives a command/report to application program A about the customer's application sub-program, the programs being used by the particular product.

Method A above, and also B, allow rapid switches between different products 13 and service providers, e.g. the manufacturers (companies) 1-4, 9, 10, 11 and 12.

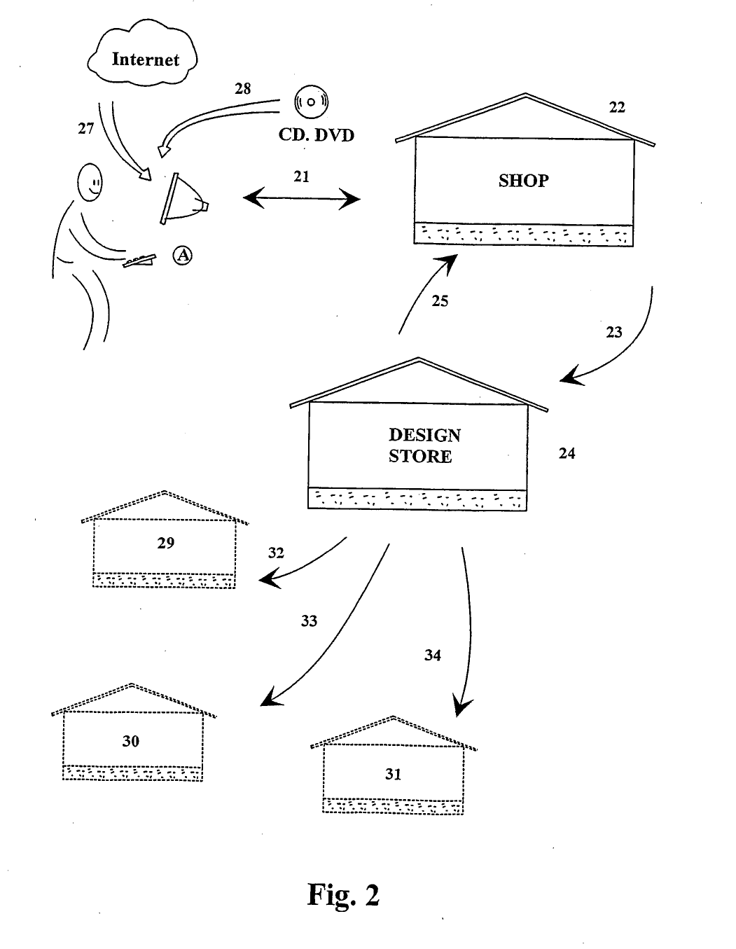

FIG. 2 illustrates a situation where the process is otherwise the same as in FIG. 1, with the exception that the customer has no program of his own, but gives commands to the service provider's computer directly 21 over the Internet. This requires the customer to be connected over the entire design process.

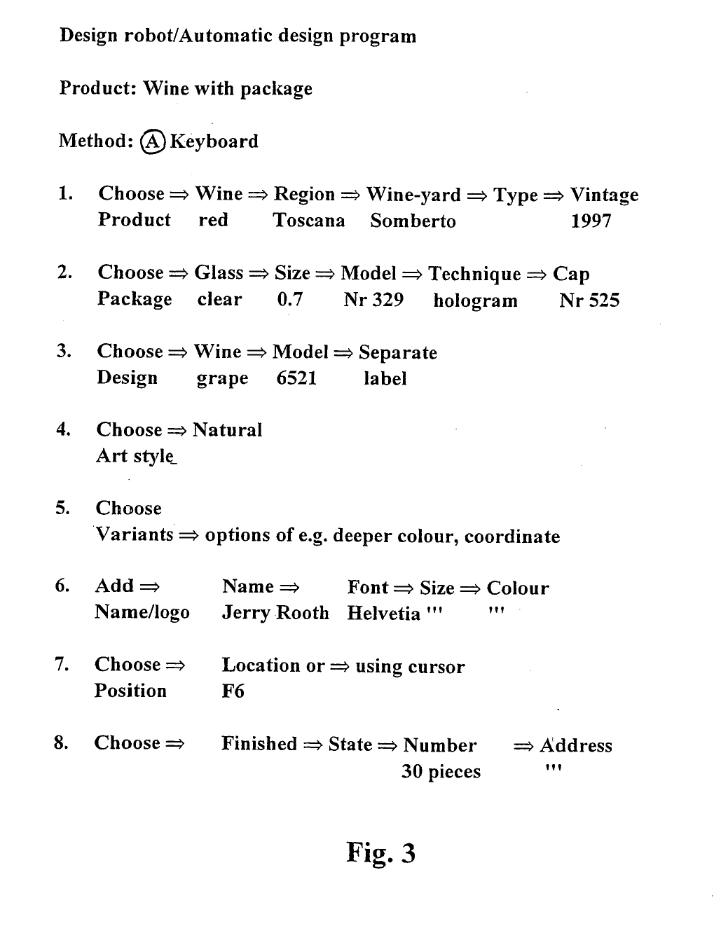

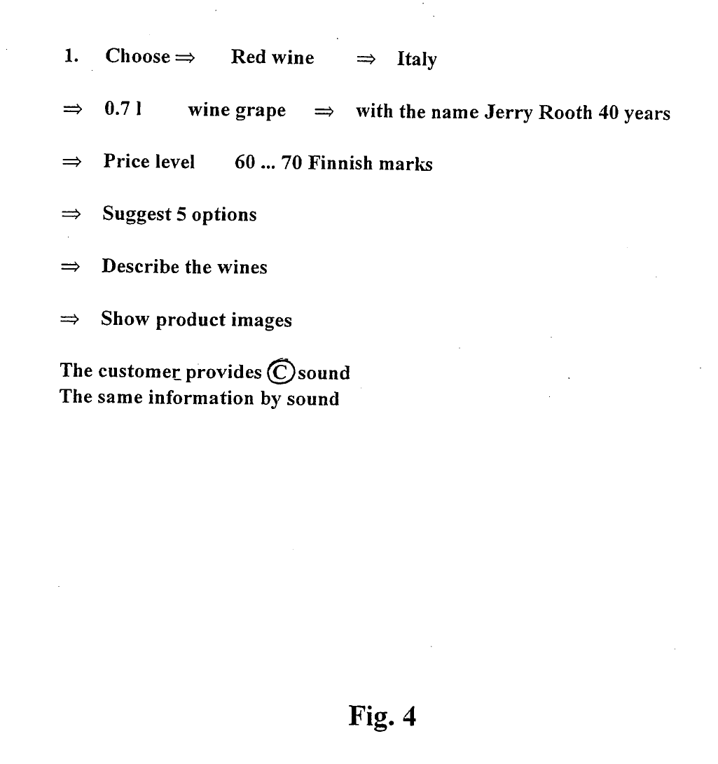

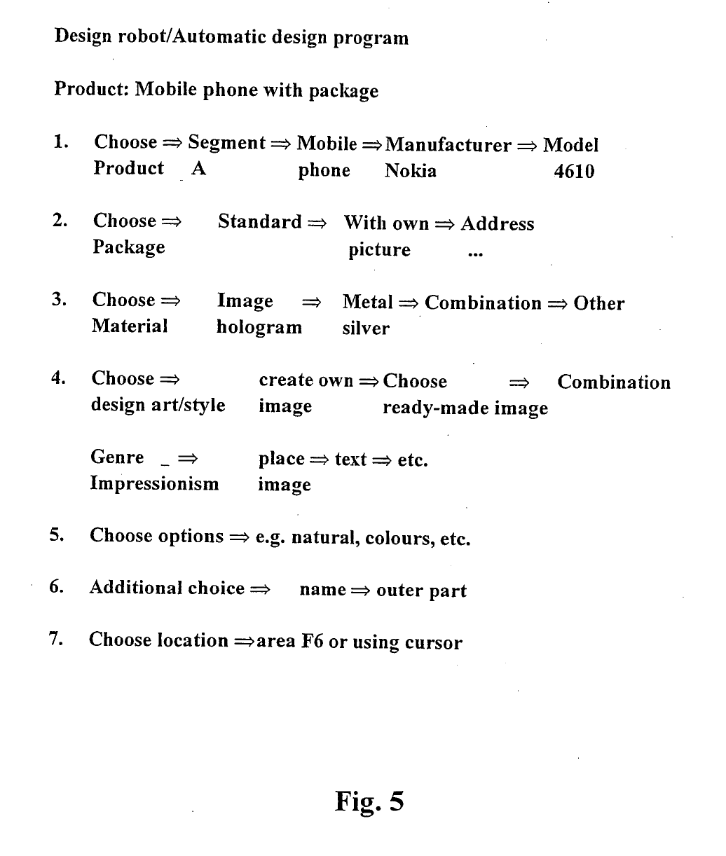

FIGS. 3-5 show a “design robot”/automatic design program, which is intended to facilitate the customer's working process and to speed up business on the Internet, since everybody is not able to use a computer efficiently. Moreover, there are things the customer does not necessarily know, such as, for instance, what a hologram looks like, what genre means, which type and vintage of wine are good, etc.

A design robot is based on customer-specific description, i.e. description of things the consumer knows or knows how to do. An automatic design method selects on the basis of provided information 1 the correct or the closest product 2, places e.g. the data on a page 3 of the type shown in picture 1, and provides the images and other data 4, which the customer accepts.

The description provided, FIG. 1 and FIG. 2, are suggestive, i.e. the image and the function may naturally be quite different in structure, and these have no impact in terms of the invention.

The examples show the relation between design robotics and a normal design process.

Making the correct choice regardless of the product and the product segment requires know-how. It is not conceivable that customers/users would know the different materials, techniques and the use of these.

A design robot included in the new method is explicitly intended to lower the design threshold.

It is enough for the customer to be able to define part of the files, the automatic design program doing the job on the customer's behalf on the basis of the information.

### Products

The method of the invention is applicable to the design and acquisition of the following products.

A. Electric and Electronic Products:

1. Mobile phones

2. Computers

3. Radio or other audio equipment

4. Watches

5. Others, such as coffee makers or water cookers.

B. Consumer Goods:

6. Bottles

7. Ashtrays

8. Glasses, dishes and others (forks, knives, bowls, trays, pot bases, cork-screws, bottle-openers, lighters, candles, vacuum flasks).

C. Building Materials.

10. Outer panels or surfaces made of metal or ceramics

11. Windows, windowpanes

12. Doors of metal, wood, glass or combinations of these

13. Walls or wall panels

14. Stone and stone coatings

15. Other

D. Furnishing Products:

16. Panels made of metal, glass, wood or ceramics

17. Mouldings made of wood, metal, ceramics or pressed pieces

18. Wallpapers, posters, paintings

19. Mirrors and mirror panes

20. Ceramic floor, wall panels, ceramic coatings, washbasins, water toilets etc.,

21. Wall or floor stone slabs and coatings

22. Other: parquet floors, laminated floors, wall or ceiling laminates, wooden floors, glass wall coatings, ceiling cladding, handrails.

E. Signboards:

23. Metal signboards

24. Plastic signboards

25. Illuminated signboards

26. Loose letters and numbers of plastic, metal, ceramics and stone.

F. Lamps:

27. Made of metal

28. Made of plastic

29. Made of ceramics

30. Made of glass.

G. Mobile Means of Communication:

31. Both externally and internally, passenger cars

32. Coaches

33. Lorries

34. Trains

35. Aircrafts.

### Manufacturing methods

The following manufacturing methods are cited:

1. Painting methods

2. Vacuum evaporation methods

3. Electro-catalytic methods (on metal, plastic)

4. Enamelling methods (on metal)

5. Glazing methods (on ceramics)

6. Printing methods (offset, rotation, ink ball, etc.)

7. Digital printing methods

8. Laser-printing/output methods

9. Colour jet printing/output methods

10. Piezo-electric spray methods

11. As a working process directly or indirectly on a 3-dimensional product

12. Adhesive-film method (only the printing ink remains on the product)

13. In-mould film method (both the printing ink and the film remain as part of the product)

14. Laser engraving methods

15. Laser burning methods (patterns)

16. Laser cutting methods

17. Water abrasive methods

18. Flame cutting methods

19. Mechanical cutting methods

20. Mechanical milling/engraving methods

21. Dressing methods (on ceramic, glass, stone)

22. Photo-resistive methods (cf. 11, 12, 13)

23. Laminating methods (wood, glass, metal, plastic)

24. Casting methods (pressure, free) on metal

25. Anodisation methods (aluminium)

26. Hologram manufacturing methods

27. Pipe bending methods (railings, handrail parts)

28. Deep drawing/moulding methods

29. Connecting external parts.

### EXAMPLES

Examples of the method and the design are given below.

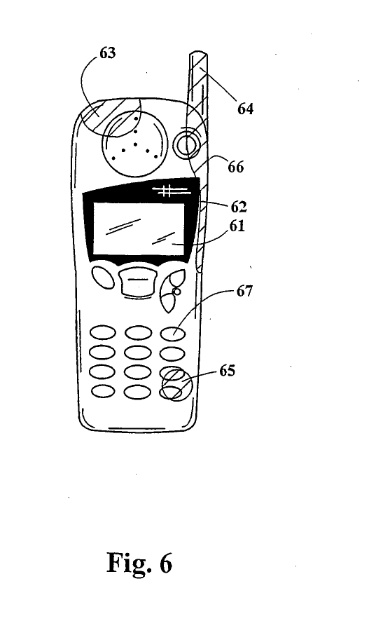

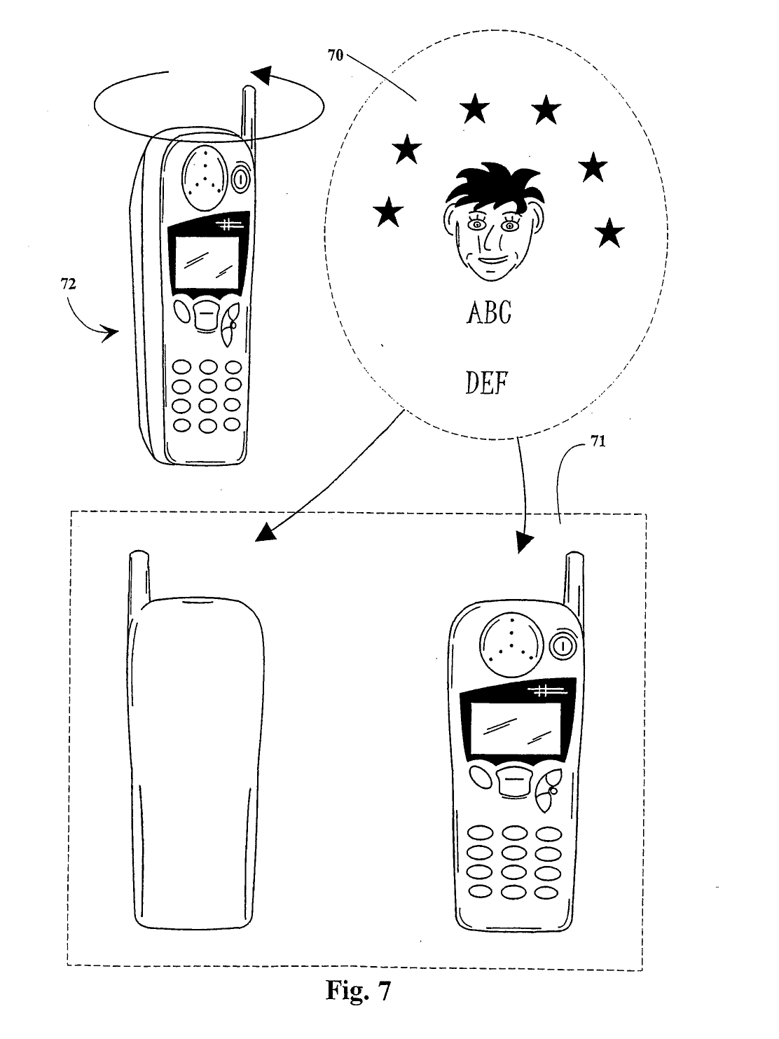

FIGS. 6 and 7 relate to the design and the order of a mobile phone.

The operation of the program is the following: the customer places or creates the image (text) he desires on a 2-dimensional application surface on the model he has chosen, Nokia 5110, for instance.

At the same time as the customer creates the surface he desires on the 2-dimensional application surface and confirms acceptation of the actions, the same operation (image) appears automatically on the 3-dimensional model, at the same location as on the 2-dimensional application surface or vice versa, first the 3-dimensional and then the 2-dimensional.

As all 3-dimensional files, this can also be turned in all directions and automatic rotation can be requested etc. Even though the geometry of the model were finished, the colour, metal etc. can be changed.

The entire program has been devised to operate in accordance with 3-dimensional and 2-dimensional geometries of the shell models given, with given restrictions and liberties, for reasons discussed below.

The reasons of the limits set to the program relate to the function of the mobile phone and to production issues. As an example, FIG. 2 shows a shell with exemplifying points that cannot be influenced with the program.

Point 61 is the display accommodating the lens, and the frame 62 should be “clean” for adherence of the lens. Areas 63 and 65 may be IR transmitter and receiver areas, 64 and 66 may be transmitter and receiver areas, e.g. antenna areas 67 and key areas.

When an image (text) is created, only these areas will be missing from the image, otherwise the images do not break or change.

There are also some models that do not tolerate metal in a given area. These are all model-specific differences, which have been taken into consideration when the program was devised.

This means that the program is completely free for creating a digital file with given restrictions and liberties.

The program also comprises many previously made files, such as options of letter and numerical fonts, ready-made images and logos.

The program also comprises a training program, samples of finished models and instructions of use etc., i.e. a complete kit:

a) The program gives access to design facilities for different shell models and related manufacturing methods or one or more combinations of these. The manufacturing methods are described in the dependent claims of the set of claims.

b) The program has pre-programmed the programmable 3-dimensional surface geometries and 2-dimensional-application image surfaces of the mobile phone.

c) The program reports the price level as the work proceeds and the overall price including transportation.

d). The customer has copyright to his own creation providing that it contains a photograph, an image he has created himself, colour coordinates or the like.

The customer designs the image and compiles the text himself or picks ready-made images and places them at 70 (FIG. 7), from where they are transferred to the shell surfaces, 71. The customer may even scan his own images into the program. A 3-dimensional mobile phone rotates continuously at 72, which continuously shows how the patterns, the text etc. appear in a 3-dimensional mobile phone. When the design of the shell is finished, order data are sent to the manufacturing company. The company selects the appropriate manufacturing methods and manufactures the shell the customer has designed and sends it to the customer by collect on delivery, for instance. The shell may reach the customer within a delay of three days.

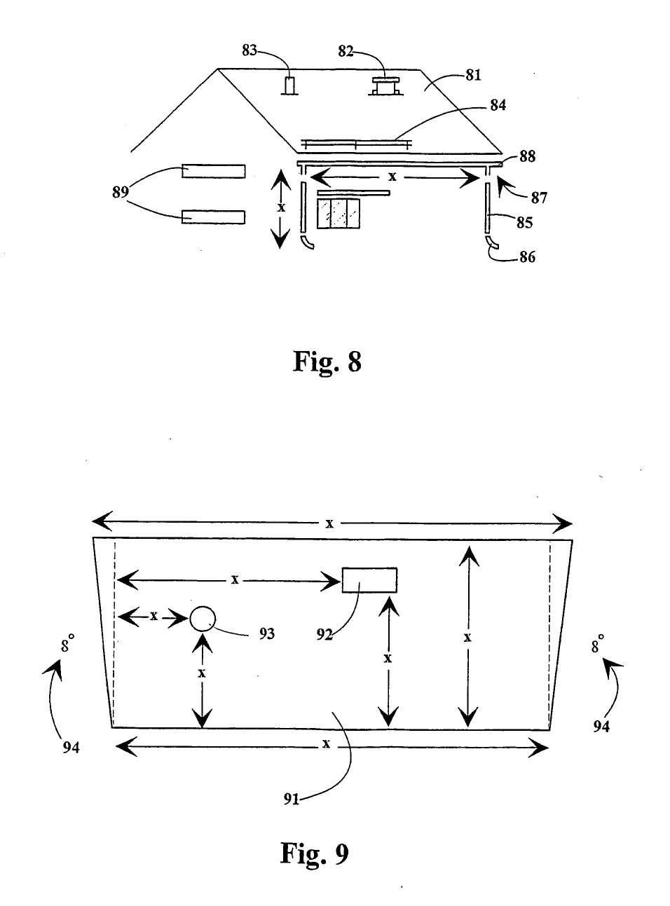

FIGS. 8 and 9 relate to the design and acquisition of parts pertaining the outside of a building.

The parts comprise:

a) Preformed metal claddings

b) Joint roofing

c) Wall panels

d) Water fumes and downspouts

e) Cornices and friezes

f) Floor mouldings

g) Door coatings

h) Other metal coatings and

i) Accessories for attachment of the parts mentioned above.

The program takes account of the following within the construction-checking program

1. Issues relating to the strength of materials

2. Issues relating to construction technology

3. Authority regulations, safety standards, for instance

4. Construction Act regulations (building standards)

5. Sector regulations, ships, for instance→Norske Veritas, i.e. classification society regulations (recommendations).

A product that would cause damage to the customer or the environment and would be a health hazard can easily be excluded, i.e. the customer is not even allowed to create such a product.

The other restrictions of the program always relate to the technical level and technical construction of the product, which the customer cannot thus influence without the permission of the manufacturing company, and items 1-5 above are not violated, should a commercial public project be concerned.

To use the program, the customer commits himself to follow the regulations of the manufacturing company in the matters above.

Hence the program takes account of technical and legal aspects, and is thus naturally subject to restrictions, and in addition, there are restrictions set by production techniques, but taken as a whole, the customer has complete freedom with regard to the coatings.

The customer wants e.g. the copper element of FIG. 1 for his building, and the element should represent an enamelled, high-resolution image in four colours of his garden, where he is standing with his dog, i.e. having a resolution equal to that of a photograph. He also wants a frame around the image. How to proceed?

1. Since the image of the garden, the customer himself and his dog are not contained in the same image, he must start with the following.

2. He may process the image as he desires by means of his own personal computer, a subprogram of the new main program, an image-editing program or a similar program of another company.

3. The image is finished.

4. The customer transfers the image to the program of the manufacturing company and selects the panel type, e.g. model 966.

5. The customer defines the dimensions, e.g. 1,000 mm×450 mm.

6. The program indicates that the image is accepted and meets all the standards.

7. The customer transfers the image he has created in the program on top of the panel he selects, checks the colours etc., accepts and orders. Meanwhile, he sees the time of delivery, the price of the product and the cost of transportation. The customer may pay with VISA card, for instance.

The following actions are taken at the manufacturing plant:

1. The program selects the working methods in the proper order.

2. Production methods→working methods→C e.g. under laser cutting 10 B.

3. Manufacture of a physical body on the production line.

4. The physical product is finished, material thickness 1.2 cu, given 3-dimensional size 1,000×450 and mode of attachment frk i.e. a screw, for instance.

5. Selection of working method B and four-colour/ink jet method by means of an adhesive film, i.e. D.

6. The work may start and it is completed within 20 minutes, and the adhesive film is placed directly on the copper panel.

7. Transfer into an oven for a period of 46 min. at +625° C.

8. Removal of the product from the oven.

9. Transfer for silver-plating of the edges by an electro-catalytic method→production techniques A item 4.

10. Period 10 minutes.

11. Removal of the product.

12. The desired pattern, e.g. a silver-plated rose, is produced→production techniques B1 laser engraving, time 7 minutes.

13. The finished product is packaged and delivered to the customer.

As noted, the customer himself creates the product he wishes, but he does not have to know or understand anything of the actual production process.

Next we refer to FIGS. 8 and 9.

2.0 The customer dimensions the roof, FIG. 8, the roofing sheet 81, the related essential dimensions and factors, such as the sizes and locations of the chimney 82 and of the air conditioning funnel 83 and the lateral angles 84 of the roof.

2.1. Next, the customer passes to FIG. 8 and gives the roof an angle α of e.g. 28°.

2.2. The customer selects the type of joint, of which there may be e.g. 30, and the segment width.

2.3. The customer selects the surface texture.

2.4. The customer has selected both the surface texture and the type of joint and has accepted these by confirmation.

2.5. The program suggests the locations of the segments and also that of the transverse joints.

2.6. If the customer accepts this as well, the program gives a complete description of the roofing, and the customer may, of course, zoom in to watch the 3-dimensional image at the angle he desires.

2.7. The customer has now used the sub-program “manufacture of roofing” in the main program, and he may now proceed to the point roofing accessories.

2.8. The customer may now start dimensioning the other products, such as water fumes 88, grooves 85, downspouts 86, weather strips 89.

2.9. After the dimensions have been accepted, the customer may further process the surfaces of the products mentioned above by any of the methods for further processing A, B or C ornamental surface mentioned above.

2.10. The customer is constantly aware of the price level as the work proceeds.

2.11. The customer places the order and receives a confirmation and other delivery conditions.

3.0. Especially item 2.9 is important; the customer starts by creating the 3-dimensional frame by means of the program, with the given liberties and restrictions, and then performs the actual design step in the program, by means of which he influences the final appearance proper, using any of working methods A, B or C.

This also applies to the products mentioned in the Patent Application, such as water fumes, grooves, panels, mouldings etc.

The improvements to the state of the art mentioned in the Patent Application relate basically to a method for manufacturing roofing of metal and for sealing the joint, and also to a method for mounting the roofing.

Since all of the sectors of a roofing have been devised and the parts have been placed at adequate positions in electric mode using the program, all the parts can be fully completed physically as well before being mounted. Owing to this a number of technical improvements can be made compared to current practice.

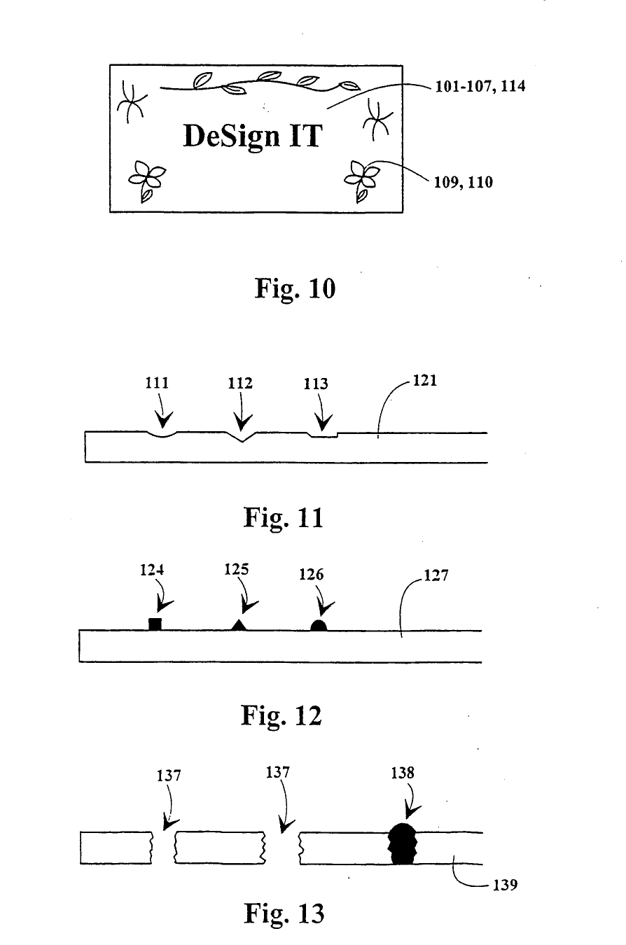

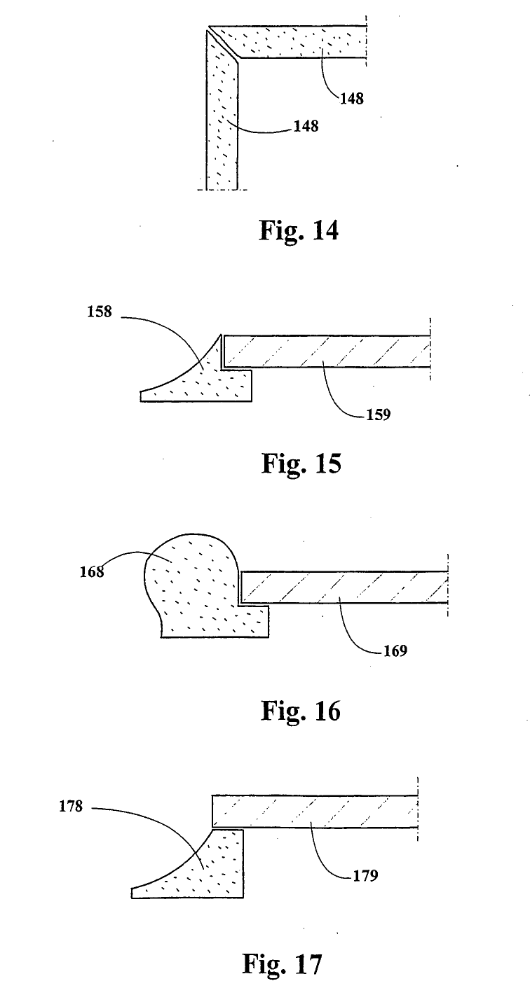

FIGS. 10-21 relate to the design and acquisition of signboards and guide boards.

FIG. 10 shows a signboard equipped with figures,

FIGS. 11-18 show various methods for manufacturing signboards and guide boards,

FIG. 19 shows a signboard of a second embodiment,

FIG. 20 shows a part of a signboard, and

FIG. 21 shows a signboard of a third embodiment.

Acquisition of the signboard or the guide board takes place as follows:

1. The customer selects the metal

a) Copper

b) Brass

c) Silver

d) Other

e) Etc.

2. The customer determines the size p×1 of the sign or the board, selects the desired one among proposed thickness values, and determines the shape of the sign or the board.

3. The customer selects the desired design from the program

a) Text recessed from the surface

b) Text in embossed letters, also separate letters by soldering, for instance

c) Text cut through

d) Font

f) Texture of a metal sign or board

g) Ornamental surface

h) Optional frame.

4. The customer selects the finishing.

a) Protective coating

b) Metal coating (electric catalyst)

c) Staining of letters and surface

d) Etc.

5. The customer selects the attachment and any other techniques.

6. When the product is finished, the customer passes the order.

Next follows a description of the production process as the customer goes on creating the product he desires, a metal signboard.

1. As the customer has ordered the product after steps 1-5 are completed, the following work process starts.

2. The program selects the adequate production technique for the product:

a) The correct metal, e.g. brass with a 6 mm thickness, is selected among the metals in store.

b) The metal sheet is cut to the size determined by the customer, e.g. S1 B-10, with laser or water jet cutting.

c) The customer is free to determine the size of the metal sheet p×k, the other changes of the 3-dimensional surface being pre-installed in the file.

d) The program contains the desired number of options, design embodiments and the desired number of fonts.

f) The customer determines the font and the embodiment (design); FIG. 11 shows laser-processing 111, engraving 112 or mechanical engraving 121.

In FIG. 12 the area between embossments 124, 125 and 126 has been removed by milling.

In FIG. 13 the metal sheet has been perforated at the letters 137, for instance, using in this case laser or water jet cutting techniques. To match this, a metal area (piece) can be cut from a second metal sheet 138 fitting into an opening of the same size made in the sheet 139.

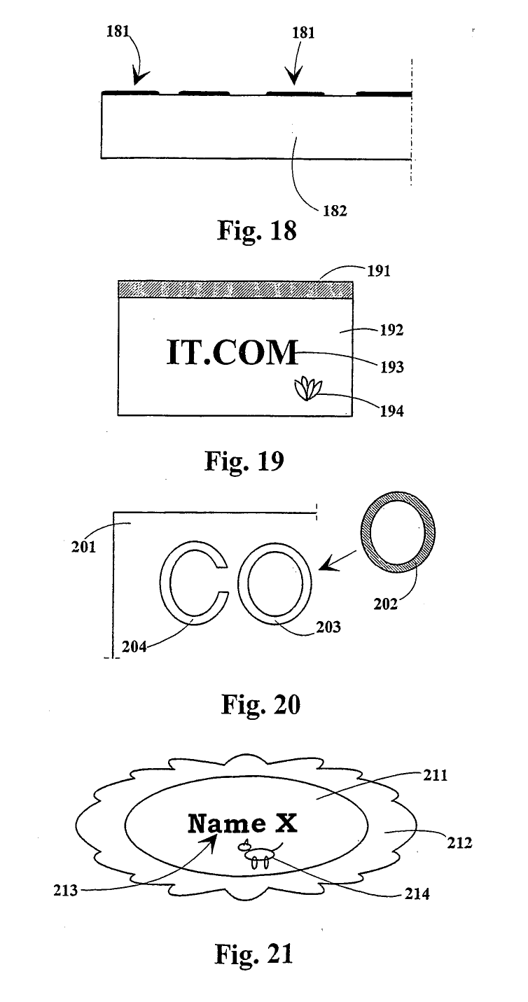

In FIG. 18 the metal sheet 182 can be coated with a second metal 181, e.g. silver or gold, etc. The entire metal sheet 182 is coated with this method.

Protective coating is applied when it is desirable to avoid oxidation of the metal surface, for instance. The coating then comprises ceramic coating, plasma coating or simply varnish.

The protective coating is thus applied last on top of the end product, and in the case of ceramic coating (glassing/enamelling), coating can be applied directly to point B or by means of an adhesive film C2, using any of the working techniques.

FIGS. 10, 11, 12, 13 and 18 can also be combined while still using, as in FIG. 18, laser processing directly on the metal, provided that the metal sheet is uncoated, in order to obtain the desired image.

FIGS. 15 and 16 also show that the metal sheet 159, 169 can be joined in a separate frame 158, 168 a) by soldering, b) by welding or c) by mechanical means. Then the frame may be made of a different material than the metal sheet proper, and it may be treated in processes identical to those of the metal sheet itself.

Because the frame 158, 168 usually consists of cast iron, it invariably has dimensions (p×k) into which the metal sheet 159, 169 should fit, given the frame already provided in the cast form.

Another way of making the frame is to cut a frame supplied by the meter automatically to the desired dimensions, with the dimensions (p×k) of the metal sheet known.

### Résumé

The customer may hence design freely a signboard or a board with the restrictions and liberties set by the program, without necessarily having to know the working processes.

### EXAMPLE

The “active light-source sign” of FIG. 19.

The light source 191, a fluorescent lamp, halogen, a discharge tube or the like emits light to the signboard 192 proper, which is made of a translucent material, such as glass or plastic. The surface or area, e.g. 193, to which light is desired, is usually milled mechanically and perhaps dressed, so that light is diffracted from these spots and the area is illuminated. The operation is usually performed on the rear surface of the signboard, but it may also be directed to the front side. Two signboards or sheets can be joined facing each other, with the unit having the same aspect from both directions.

The milled areas are usually painted, so that the illuminated area is brightly visible in the desired colour.

It is also known for the customer to combine some other conventional method. An example of this is a real hologram 194, the manufacturing company selecting the working method either directly or indirectly on the work piece. The customer may naturally design the size (p×k) and freely choose his actions within the program.

FIG. 20 shoes a signboard of metal or plastic, which has a sheet-like base plane 201, to which an external member 202 can be joined by adhesive film, or areas 204 and 203 can be removed from the sheet 201 by some manufacturing method. The customer may also maintain the original planar sheet surface 201, starting, for instance, by removing the letter area, cutting from another material or metal a corresponding 0 letter 202 and joining these by some new working method.

The metal signboard shown in FIG. 21 is made by pressing or casting. It is an example of a signboard used in doors or say, letterboxes, which usually carry the customer's name.

In the exemplifying case, the signboard has been pressed from laminated metal or pressure cast. The customer cannot influence the 3-dimensional shape regarding the signboard proper. However, the customer can freely choose and design anything within the program by using any of the production techniques directly or indirectly.

The signboard in FIG. 21 has been pressed from 0.6 mm brass, with silver selected as a coating on areas 211 and 212. The manufacturing company selects a new electro-catalytic silver plating.

Next, the customer designs e.g. his name 213, wishing to have it in patinated brass, for instance. The manufacturing company then selects laser processing as the working technique, resulting in accurate removal of silver from the areas the customer desires.

In addition, when the customer wants e.g. a picture 214 of his dog on the signboard, he scans a picture of the dog and places it in the desired size on the desired spot by means of the program.

The manufacturing company then selects the working technique, creating with the aid of adhesive film D exactly the image the customer has planned on the signboard itself, which then is finished.

FIG. 19 shows a hologram signboard. In the case of a “real” hologram, conventional methods always require an real piece, which, in the course of the process, is transferred to an adequate base to form the hologram image 194.

Accordingly, this always requires a physical installation, of which a hologram image is created from real 3-dimensional bodies using known processes.

Then the customer creates the picture he desires using his program. When the file is ready, he transmits it to the manufacturing company. Here the difference lies in the fact that the customer makes a choice between ready-made pieces, using these to create the installation picture material. The manufacturing company may have at its disposal all the plants, the animal world that can be borrowed from a zoological museum, for instance, different types of letters, numbers, various wooden materials, stones, etc.

The manufacturing company creates the installation on the basis of the file compiled by the customer, then carries out the process, and the customer receives the hologram signboard he wanted.

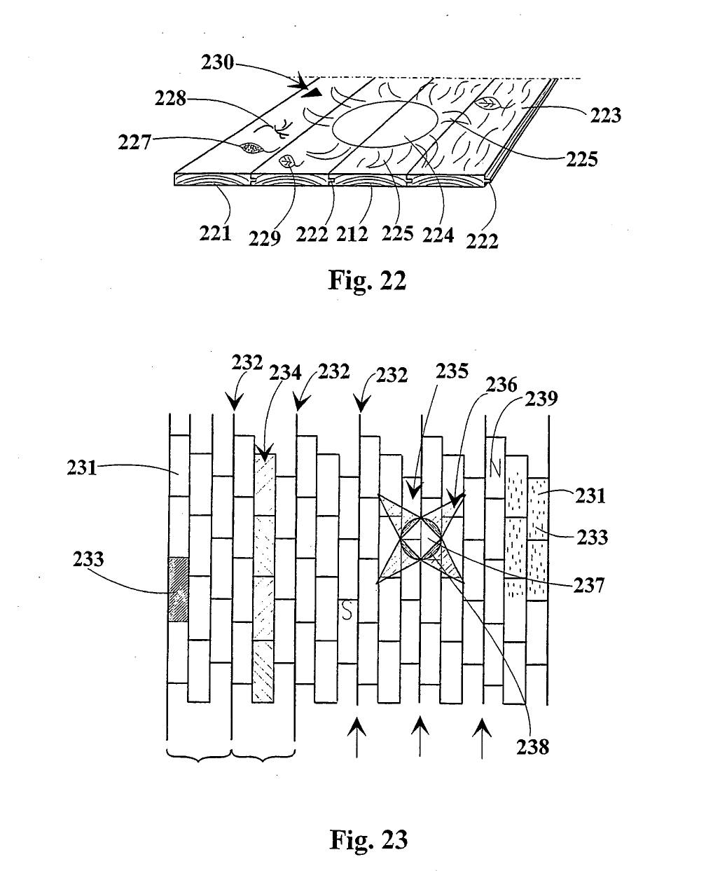

FIGS. 22 to 29 relate to the design and acquisition of wooden parts pertaining to the furnishings of a single-family house.

The method is simply based on the fact that the program, which has been devised for digital control of predetermined working processes, is simultaneously a program allowing the planning of the wooden components required for the construction, this planning being consequently performed by the customer.

This means that all the working steps can be digitally performed, i.e. a digital signal can be transformed under control into the desired end product.

Using a processor and a program, the dimensions and surface pattern of a parquet floor, for instance, can be transformed into direct current, a pulse, or pneumatics can be controlled so as to allow production of the surface pattern and the dimensions devised by the customer, with the product adequately positioned at the working point, i.e. point 0 of the product and point 0 of the digital file coincide in the xyz coordinate system.

The program of the method sets restrictions and gives liberties for the customer. Without special permission, the customer cannot influence the “technical” level of the product, i.e. the technical construction, design or the like, such as the thickness of a parquet floor.

A “construction checking program” (ccp) has been included in the program provided in the server to ensure that the execution of the work meets the requirements in terms of strength of material. The program also enquires about the object and country of use in case these do not appear in the contact. In any case, the ccp program has been devised so as to constantly ensure that no erroneous product can be ordered without special permission. The ccp program also reports this to the customer and suggests a correction.

The program is also devised so as to indicate the acceptable load for a floor, for instance, which the customer ought to and is entitled to know.

Of course, the program can be compiled so as to allow only the creation of material thickness and constructions exceeding given minimum requirements.

A ccp+state line has also been included in the program, denoting authority regulations and construction act provisions, provided in the program country wise or say, within the EU.

The ccp program provided in the server takes account of

1. Issues relating to the strength of materials

2. Issues relating to building technology

3. Authority regulations, e.g. safety standards

4. Building act provisions (construction standards)

5. Sector provisions, e.g. ships→Norske Veritas, i.e. regulations of classification companies (recommendations).

Any product that would cause damage to the customer or the environment and would be a health hazard can easily be excluded, in other words, the customer is not even able to create such a product.

The remaining restrictions of the program always relate to the technical level and construction of the product, on which the customer cannot consequently act without the permission of the manufacturing company, not violating items 1-5 above in the case of a commercial public project.

In order to use the program, the customer commits himself to respect the company's regulations as mentioned above.

Hence the program takes account of technical and legal aspects, naturally setting limits to the production, which is also subject to restrictions in terms of production techniques, yet as a whole, the customer has complete freedom regarding the creation of the surfaces.

The production techniques cover the following methods:

A. Coating Methods

1. Painting

2. Varnishing

3. Staining, lye

4. Aqua graphics

5. Any other coating method, e.g. lamination

B. Processing Methods

1. Laser processing/engraving

2. Laser burning/marking

3. Methods for making holograms

4. Laser output methods

5. Colour/ink jet methods

6. Silk screen techniques

7. Offset and other printing techniques

8. Pneumatic/electric jet techniques

9. Piezoelectric extruding head techniques

10. Mechanical milling/engraving

11. Laser or water jet cutting.

C. Working Methods

1. Sawing

2. Planing

3. Dressing

4. Turning

5. Gluing/pressing to shape

6. Pressing/compression

7. Drilling.

The invention is described below by means of an example and with reference to the accompanying drawings, in which

FIG. 22 shows an axonometric view of a parquet floor,

FIG. 23 is a top view of a parquet floor,

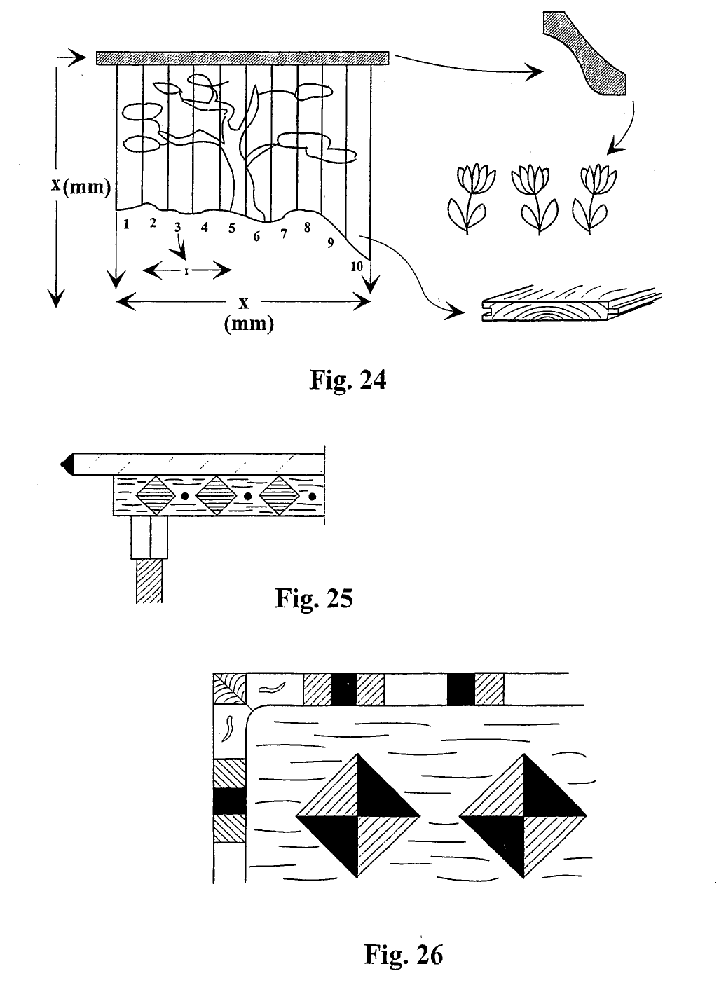

FIG. 24 shows a wall panel,

FIGS. 25 and 26 show patterns in wooden surfaces,

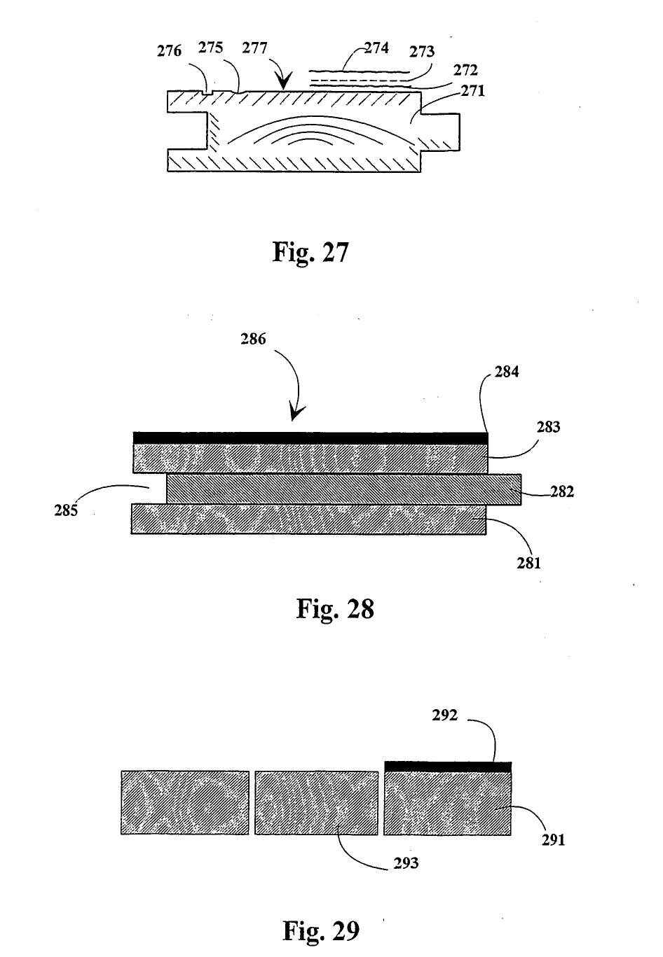

FIG. 27 is an end view of a board in a parquet floor,

FIG. 28 is an end view of a board in another parquet floor, and

FIG. 29 is an end view of battens in a parquet floor.

In a jointed or boarded floor, which is probably globally the best known and most widely spread type of floor, the actual basic type naturally depends on the geographical location of the object. A plain jointed floor is given as an example, however, the abutment may equally well be of some other type or not used at all. The type of floor and the wood species have no impact in terms of the invention. However, the customer may influence both the methods, given the basic idea of the invention, i.e. that the customer creates and orders exactly the kind of floor or wooden component he wants.

In FIG. 22, the floor is composed of floorboards 221, which are jointed 222. Thus, for instance, the customer has started by choosing the wood species; pine, for instance, and then created the file, i.e. the image and the colours. Of course, it is possible to start by creating the image and then go on to selecting the wood species. In FIG. 22, the customer has first created e.g. a sea star 224 and 225, a cone 227, a branch 228 and a birch leave 229. 230 represents the space in which the different wooden species are embedded.

In FIG. 22, the floorboards 221 run in parallel. This is but one example, and the customer is free to place them into different directions, or the floor boards 221 may have different width and also be made of different wood species.

In the production of a floorboard, working methods 1, 2 and 3 among the production techniques C above have naturally been used before the flooring can be further processed. Within the program, the customer may choose between a variety of architectural styles and designs, create his file, edit and change it and finally approve.

In creating the image in FIG. 22, the customer has known different variants, of which some examples are given below.

A. The customer desires images burnt into wood, and then the manufacturing company offers the option laser processing/laser burning B1 and 2. The set of images created can then be burnt by laser (cf. FIG. 27) directly into the wood 275 or on primer varnish 272, for instance. It is also possible to proceed by removing by means of engraving laser an area of primer varnish 272, and then go on by filling, i.e. coating with lake, stain or the like the areas devoid of primer varnish 272.

The desired image can also be obtained by coating with e.g. techniques B5, 8, 9 directly on wood 277 or on a layer of primer varnish 272, or indirectly on the product itself using an adhesive film and techniques B4, 5, 6, 7. If a different species of wood is desired at the pattern, the desired thickness is removed from the wood, FIG. 27 point 276, or a hole is drilled and a piece of the desired wood species is mounted in the recesses formed, is fixed by gluing, for instance, and is polished after drying. The recesses are formed with techniques B 10 and/or 11, for instance. A preferred way of achieving the desired pattern is for the customer to select the wood species and the processes it is subjected to.

The manufacturing plant selects the correct working technique, a recess, e.g. B 10 and/or 11, and the actual veneer, which has e.g. a thickness of 2 mm, is cut from a larger sheet using working technique B 11, for instance.

Then the components will tally with one another with high precision.

The work can be done directly or indirectly, using an adhesive film, for instance, directly on the wood or on a varnish layer on top of this, and the pattern can be freely formed, using a variety of wood species, by painting, varnishing and staining.

In the example of FIG. 23, a parquet floor is created in the same way as in FIG. 22, however, the construction proper is different, because the parquet floor has been composed, as shown in FIG. 28, of thin or thick veneer boards 281, 282 and 283, or they may comprise a thin face veneer 284, which usually is flawless and more precious.

A square parquet (FIG. 29) is by definition formed of squares made of solid wood 293 or by coating solid wood 291 with a thin veneer layer 292, in any case usually top varnished, but it may also be without varnish.

FIG. 23 illustrates a parquet segment 231, which is formed as in FIG. 29, usually with the surface shown in FIG. 23 formed of a plurality of smaller veneers 292 laminated on top of the base. One segment usually has a 200 mm width→maximum 6 m length, and the limit of one segment has been jointed or may choose among a variety of wood species, which have possibly been further treated in various ways, e.g. stained, coated with lake, laser patterned or equipped with any other image. The same applies to the compass 235 shown in FIG. 23, in which wood has been utilised as described above to form the desired image.

Since all the working processes, including the image processing, the control and the file created by the customer, are in digital form, as is data transmission over the Internet, the customer may advantageously order only a sample, i.e. part of a whole.

This allows the customer to ensure that he gets the product he desires.

A second major benefit is that the working processes can be performed advantageously and with precision even in the case of a comprehensive global task, implying that the work object needs not have the size of the entire product (flooring), but the size of one single segment, for instance.

Unless the production processes entailed by the production techniques allow digital control or processing, as in the creation of complex images, the customer's file, which is naturally also in digital form, would be worthless.

Meanings of the words used above:

Wood (door, flooring, ceiling and floor mouldings and wall) mean that the product is made of solid wood, e.g. birch, maple, oak, ash, pine etc., and it may be jointed, planed or milled to shape. The wood may also be compacted in a more dense and hard shape in a “thermo-compressor”, usually together with other substances, such as maleic acid.

A parquet (flooring) is also made of wood, but manufactured in the same way as a veneer sheet. i.e. made of veneers and usually jointed. There are also “square parquets”, in which an integral separate piece is thicker than veneer. The veneer has a thickness of 0.3-2.5 mm, whereas a piece has a thickness of 2.5-10 mm.

A laminate (surfaces, doors, floors, furniture) is usually a plastic-based, film-like or sheet-like surface, which is laminated on the product itself, e.g. a door, a table etc. Then the base material is usually compressed wood fibre MDF or a material of chipboard type, however, veneer is also widely used.

Veneer-coated products comprise furniture, floorings, doors, mouldings, walls, etc.

MDF-based products comprise doors, mouldings and coatings.

The design and production of wood-based products by means of the Internet program are described below.

The customer then selects the wood species, e.g. birch, the thickness and the width of the product, and makes the design he wishes by means of the Internet program.

FIG. 22 shows an example, where the floorboards 221 have been patterned by burning, B 1 or 10, using a laser, which burns the wood surface according to the created program. This allows the creation of the desired surface directly on wood or on varnished wood.

If the process has been performed directly on wood, one may proceed by staining (dyeing) the laser-patterned surfaces with stains of different colours, each one separately, using method B 7 or 8, and then the wooden surfaces can be means that laser can be used to define the surface whose colour varies each time.

In FIG. 22, several boards can be made simultaneously or one board made at a time. This has no impact as such, since the end result is the same in both cases.

FIG. 23 shows parquet flooring whose outmost veneer layer has been varied (designed) using the customer's file.

There may be up to 50 wood species available in the program, and then the working point comprises at least, B 10, a laser or water jet cutter, by means of which the veneers are cut on the basis of the file (design) compiled by the costomer.

Then the veneers, usually of the size 120×200 cm, may be placed with the veneer to be used ready for transfer to the working point. The veneer may also be a previously lathed veneer, i.e. wooden surface (planed). The working point may be a large “suction table”, to which the veneer adheres by suction over the period of the process. The veneer is then planar and can be cut, e.g. B 10, with laser in conformity with the file.

After this, a linearly moving robot having suction pads at the end of its suction surface grips the cut veneer and places it at exactly the correct position.

This process is pursued until the surface, i.e. the product is veneer-coated.

The same applies to a square parquet construction. Usually square parquet is made in the same way as veneer parquet, but square parquet can also be mounted directly on the base floor.

It is also conceivable to remove the surfaces that will differ from the standard by mechanical milling, such as B 6, from a standard parquet floor.

In other words, the customer can design a parquet floor all the way from the beginning, or he can alter a standard floor.

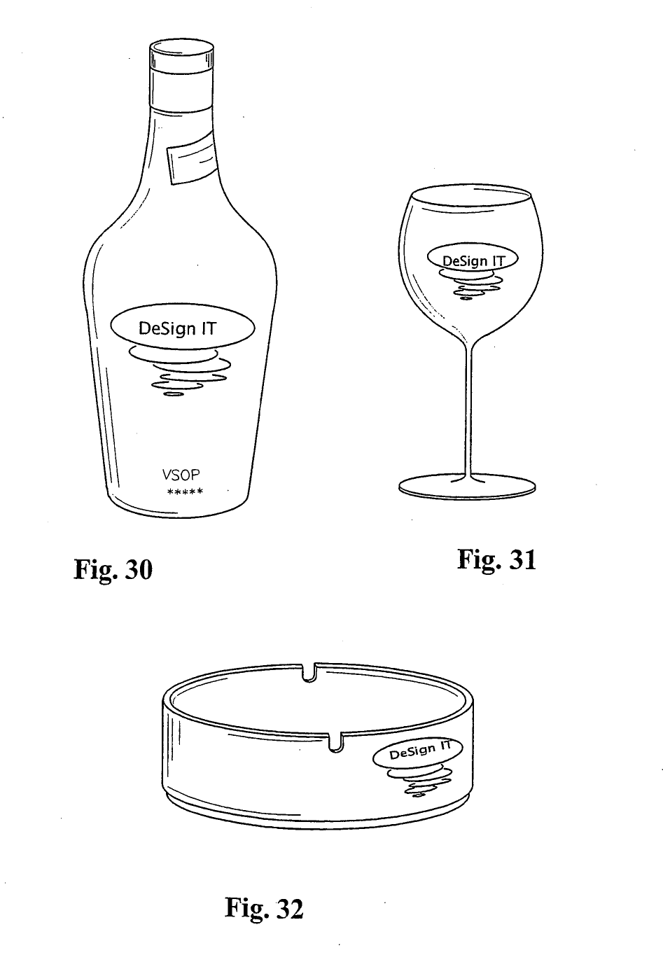

FIGS. 30-33 relate to the design and acquisition of a glass product.

FIGS. 30-32 show a bottle, a glass and an ashtray, on whose surface the name and the related logo designed by the customer have been produced with the method of the invention.

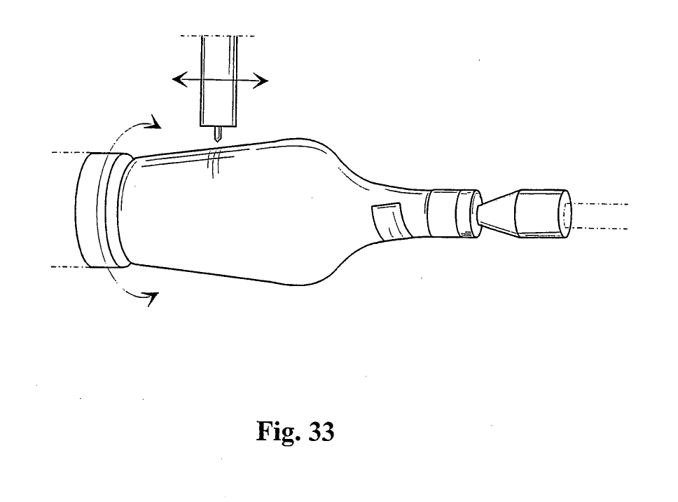

FIG. 33 shows the surface treatment of the bottle with a piezoelectric jet or laser.

In the case of a consumer product, such as a bottle, for instance, it will always be in the correct 3-dimensional physical shape, in other words, the customer cannot act on the model, but picks a basic bottle in the selection for which he wants actions to be taken.

The bottle may be made of glass or ceramics.

The customer creates a file, i.e. the design, with the liberties and restrictions set by the program.

In the most straightforward form, the customer creates a paper or plastic label, which is printed and fixed to the product the customer has chosen.

If the work is directed to the product itself, it can be carried out as shown in FIG. 33, for instance, using a piezoelectric jet or laser.

Printing inks or glass staining colours can be used, and then laser engravings or protective varnishing can be made on the surface, which are removed from the areas where the etching is intended to act.

It is also possible to manufacture a real hologram on a bottle by means of laser, because the exact x, y and z coordinates of the product are known. Then the customer transmits the theme of the hologram he desires for the product, or chooses one or more figures in a register, positions them in image form, sends the file, and the manufacturing company produces them in accordance with the installation instructions.

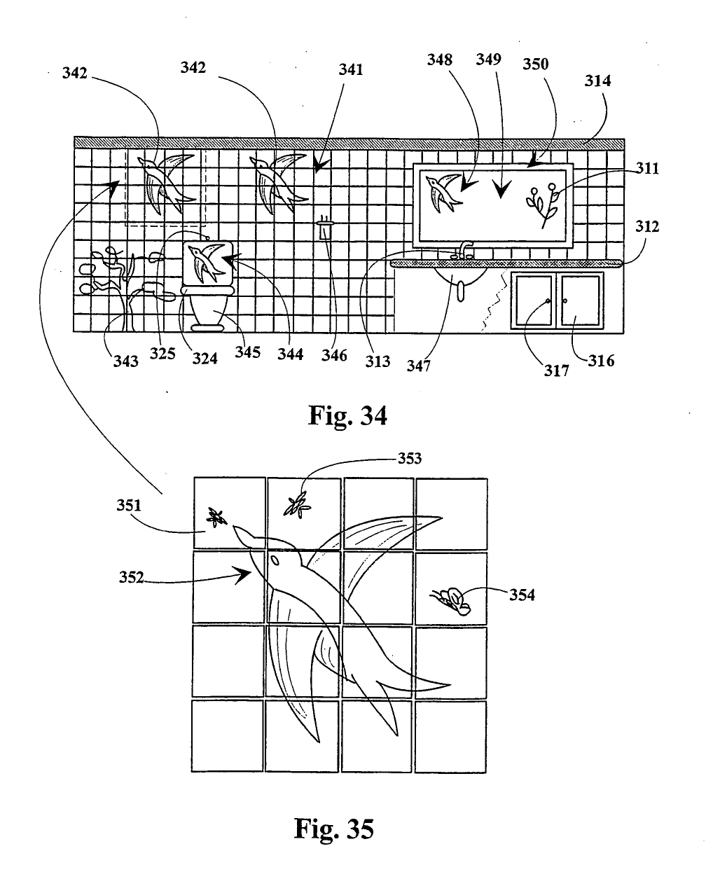

FIGS. 34-38 relate to the design and acquisition of products made of ceramic, glass and stone.

The products comprise the following, among other things:

a) Ceramic floor tiles and coatings

b) Ceramic wall panels and coatings

c) Ceramic mouldings and ornamental coatings

d) Other ceramic furnishing components and coatings, such as ceramic sanitary appliances and related parts and articles

e) Wall and ceiling panes and doors made of glass

f) Glass mirrors and glass surfaces

g) Windows

h) Tables and table tops made of glass

i) Consumer articles made of glass

j) Planes made of stone

k) Tables and table tops made of stone

l) Floors and wall surfaces made of stone

m) Furnishing and ornamental articles made of stone

n) Tombstones and stone monuments.

FIG. 34 shows the wall and products of a sanitary space,

FIG. 35 shows a partly enlarged view of a wall,

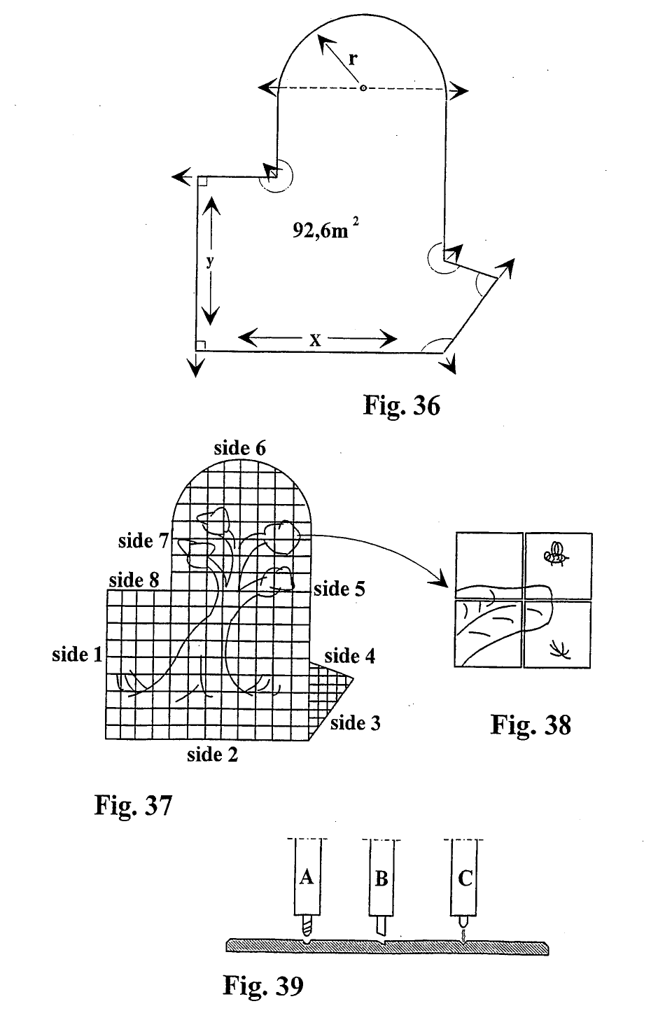

FIGS. 36, 37, 38 and 39 show a ceramic floor,

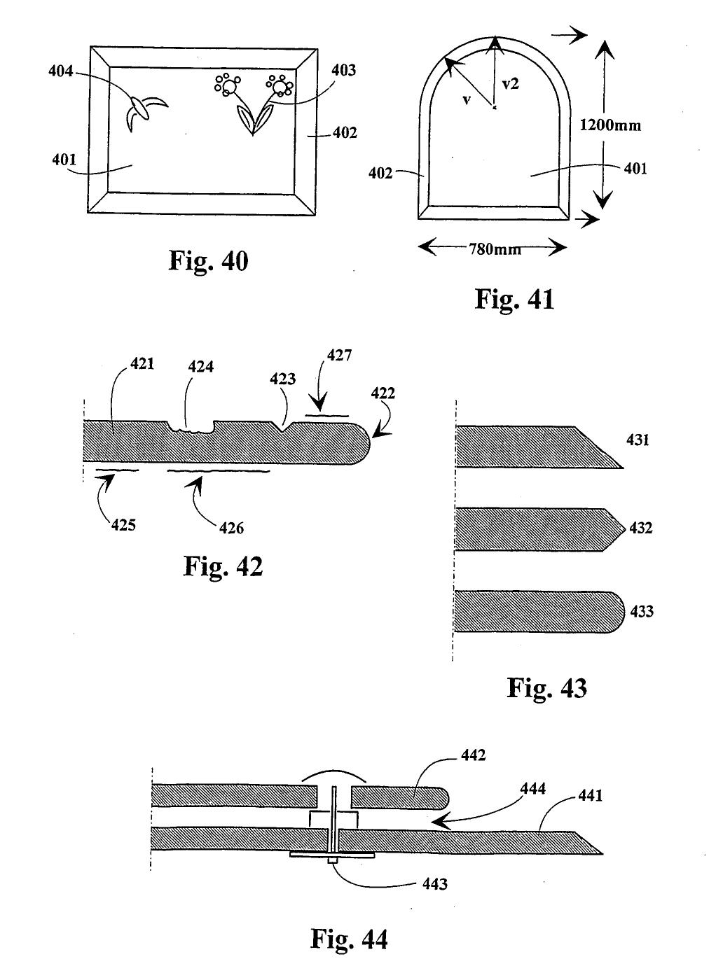

FIGS. 40-44 show glass mirrors and their production processes

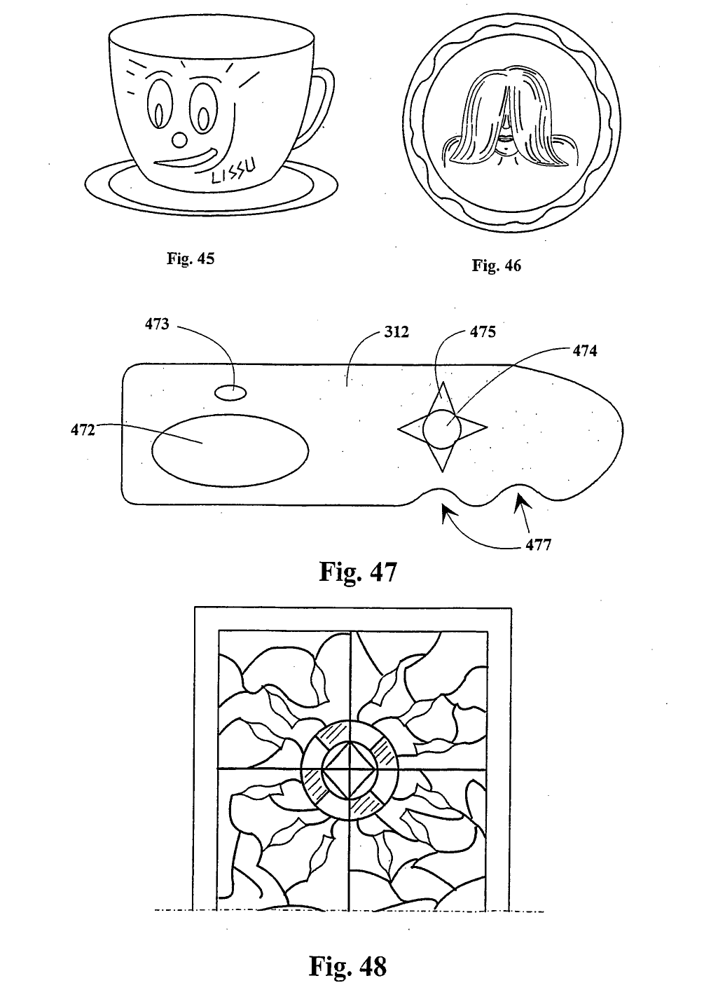

FIGS. 45 and 46 show consumer articles,

FIG. 47 shows a table top made of stone, and

FIG. 48 shows a “gothic” window.

The production technique comprises the following methods:

A. Coating Methods

1. Silver plating (chemical silver-plating process)

2. Vacuum evaporation (process performed under vacuum)

3. Metal coating (chemical metal-coating process)

4. Ceramic coating (glazing)

B. Working Methods

1. Laser processing/engraving—laser burning/marking

2. Hologram manufacturing techniques

3. Laser printing techniques

4. Colour/ink jet techniques

5. Silk-screen techniques

6. Piezoelectric jet techniques

7. Electrically operated techniques

8. Offset and other printing techniques

9. Pneumatic injection techniques

10. Mechanical milling/engraving/grinding/polishing

11. Laser or water jet cutting techniques

12. Axial and 3-axial work plane comprising a mechanical process, performed e.g. by a hammer gear.

Since production techniques are group-wise uniform regardless of the product, e.g. ceramic products, the figures are equipped with captions and numbers.

Thus the first group comprises ceramic products, FIGS. 34-38 and FIGS. 45 and 46, comprising the areas 1-7 and a more specific exemplifying case includes ceramic wall tiles and surfaces.

The invention is compared with the figures below.

FIGS. 34 and 35 show ceramic wall tiles and coatings.

The figures show a bathroom wall equipped with typical appliances.

The wall has been formed of ceramic tiles. The customer has determined their sizes, shapes, positions and 3-dimensional surface. The customer has placed the products he desires at the locations he desires; he has started by selecting the products, placed and designed the surfaces, forming the assembly shown in FIG. 34. He is free to exchange the products, change their positions and redesign them in the course of the process. The customer may, for instance, design one single separate part 346, a glass and its holder, or a complete bathroom including walls, floor and lighting. He may order a sample of a part, to ascertain a colour or an image, or he may build up the proposed bathroom gradually in the course of years.

In FIG. 34, the customer has created the entity he wanted including all the separate products.

The wall tiles are shown at point 341, and point 342 shows how birds, such as swallows, have been created and placed in natural size at the desired location. Then the customer has scanned the actual object from a bird book or taken the bird picture from a homepage directly via the Internet and placed it in the memory of the design program, from where he has taken it into use and placed it where he wants it. The picture has also been used in other products: in the front part 344 of the toilet and in part 348 of the mirror 349. This production technique is different, because the mirror is not glazed, i.e. not burnt, so that the production techniques are one of B.1-9. without using stain colours i.e. glazing. By contrast, the same production techniques B.1-9 are used for the ceramic surfaces 341, 342, 344, but glazing, i.e. silicate-based. stain glazing is used.

Hence the basic production techniques are the same, but due to the different further processing required by the coatings, the manufacturing process will be different from working steps B.1-9 onwards.

The customer may have used his own digital camera to take a shot of a tree 343 and transferred it to the design program.

The colour of the toilet can be chosen or altered quite freely.

The customer has also positioned a glass holder for tooth brushing. He has naturally designed and shaped the glass himself (cf. FIG. 45).

There is also a table top made of stone 312, for instance, (cf. also FIG. 47), in which a ceramic wash basin 347 has been selected, for which matching perforations have been made in the stone base 312. The stone table top 312 has been dimensioned and put into place.

The water tap 313 has been placed at a location on the table top 312 where it tallies with the ceramic basin. The stone material of the table top 312 can be freely chosen among the stone materials available in the program, or then the customer may order a special stone material using the program.

This means that the manufacturing company surely cannot keep all the stone qualities in the world in store, but there is a list of the stone qualities not on store in the program of the manufacturing company, and if the customer picks a special stone quality not in store, he will immediately see the delivery time.

The customer can design the toilet 345 and the washbasin 347, in the same way as the other ceramic parts.

The toilet cover 324, which is usually made of plastic, and the flush button 325 of the toilet, can also be freely shaped.

The customer has placed a mirror 349 of the desired size on the wall, planned facetted dressing 350, placed the bird 348 where he wants it, and also a flower array 311, for instance. He has also chosen the ceramic ceiling moulding 314, the doors 316 and their knobs 317 in the ready-made program, altering or designing them from the beginning to the end.

The customer has thus created a whole, and when placing an order, he receives a mounting and dimensioning chart, where the products may also be numbered, however, with the actual dimensioning appearing in mm. in the customer's own program, so that mounting is accurate and easy.

341 in FIG. 34 and 351 in FIG. 35 show the selected tile size and the locations of the desired graphics and of the bird pattern 352, e.g. a swallow scanned from say, a bird book, fetched over the Internet or created by the customer. The figure also shows the position of insects 353 and 354. The ceramic tile may be numbered.

FIGS. 36, 37 and 38 show the ceramic floor, the dimensioning of the room, the position of the tiles and of the desired image 37, and an enlargement of a detail in FIG. 37 is shown in FIG. 38.

This is exactly the same process as for a ceramic wall, FIGS. 34, 35, but next the operation of the dimensioning and the tile positioning process will be studied.

The customer makes the dimensioning of the room by giving the dimensions of all the sides “side 1 to side 8” say, in mm or cm (FIG. 36). At the same time, he gives the degrees 0-360° for all the angles and the radius r of the side 6.

In FIG. 36, the room has been dimensioned and the program indicates the square value 92.6 m².

The customer selects the tile dimensions, determines the joint widths, designs the surface, i.e. the floor, and the program places the tiles planned for the room in FIG. 36. FIG. 38 is an enlargement of a detail of FIG. 37.

The room is ready and the customer confirms the order.

Ceramic tiles, coatings and products are usually manufactured by first compressing the basic element, the “bottom”, which has e.g. a thickness of 5-15 mm regarding the tiles, depending on the object of use, from wet clay/ceramic material to the desired shape.

Then the “bottom”, the compressed product, is slowly dried to contact hardness, after which the “bottom” is put into an oven at high temperature i.e. is burn to become hard.

After the steps above, the “bottom” can be glazed and burnt, resulting in the desired glazed ceramic product.

The other methods for further processing and processes have been described above, the following description relating to the 3-dimensional shaping, i.e. individualisation of the product.

To obtain the desired end result, the process can be carried out in two optional ways: either directly on the work piece, or indirectly by manufacturing a press mould, by means of which the ceramic material is pressed.

The desired individualised 3-dimensional shaping can advantageously be performed as in FIG. 39:

A. Mechanical milling

B. Mechanical engraving (with a non-rotating mill grinder)

Mechanical printing by means of variously shaped “blades”=objects.

C. Engraving laser

The measures above are preferably taken after drying, or after the burning of the actual “bottom”.

In terms of programming techniques, 3-dimensioning is easy by means of existing programs, using images, for instance, and it will become even easier in the future, when programs created for this purpose can directly yield a file that transforms a 3-dimensional imaged created by the customer into a file for controlling a number of proposed working processes A-C under personal computer control.

FIGS. 40-44 show a glass mirror and how it is formed.

In FIGS. 40-41, the customer gives the dimensions of the mirror 401 he wants, i.e. gives the shape, selects the glass thickness, designs and selects the edges, i.e. the facets 402. The customer may also select the mirror colour, which may be glass or a colour achieved in the glass by the work process (production techniques 1, 2 and 3). The colour range is unlimited in the practice.

Then the customer plans the image 403 he wishes, which may be a 3-dimensional flower array, i.e. a physical operation is directed to the surface of the mirror glass by means of any of working methods B1 or 10.

A bird 404, for instance, can be made with another of the proposed methods, e.g. an adhesive film, on which the image has been printed with method 3 or 4.

The customer has thus completed the design of his mirror.

FIG. 42 shows how the different operations are directed to the glass, which then will form the mirror designed by the customer.

In the figure, reference numeral 421 indicates the glass material whose thickness the customer has chosen and which he has designed while choosing the border, i.e. facet 422 he desires. Reference numeral 423 indicates a notch achieved with a mechanical operation using e.g. any of work methods B.10, thus forming a 3-dimensional image. Reference numeral 424 denotes laser engraving, which does not penetrate into the material, but is usually applied in connection with printing 427, or independently, yielding a satin-finish pattern. Reference numeral 425 refers to printing on the rear side of the glass, however, always inside the actual mirror surface 426, because it would not be visible through the mirror pane otherwise.

All of the operations mentioned above can be carried out on either side or both sides, yet with the mirror surface constantly on the rear side 426.

It is also known to form a real or fake hologram on a mirror glass.

FIG. 43 shows examples of edges, i.e. facets 431, 432, 433.

FIG. 44 shows how the customer may compile a “layered mirror construction”, comprising a lower mirror 441, to which an upper mirror 442 has been attached e.g. by means of a bolt 443, leaving a gap 444 between the mirrors 441 and 442.

FIGS. 45 and 46 show typical “consumer articles”, such as a mug, a glass or a plate made of ceramic material or glass.

FIG. 47 shows the table top made of stone of FIG. 34 at point 312, for which the customer selects himself the stone material, e.g. grey gneiss, places the ceramic wash basin designed by himself into a hole 472 made in the stone material, and selects the water tap, for which an adequate hole 473 has been provide in the stone material. The customer performs the planning and the dimensioning, gives the radii for the angles and other shapes 477 for the stone thickness he has chosen. The working methods used so far are B.10 or 11.

An image can be formed in the stone material in several ways, of which three options are exemplified below, yet it is understood that there may be more working methods.

Option 1

The patterns 474, 475 on the table top 312 may be made of stone materials different from the table top proper. Then the exact area where the pattern is formed has been removed from the table top itself either using working method B.10 or 11. The separate stone parts can be advantageously manufactured with the same methods.

Now the table top comprises a recess or a through-hole, whose shape accommodates separate stone parts in exact positions.

Option 2

The pattern 474, 475 can also be formed on the table top 312 by means of the chipping method B.12 or the laser processing/engraving-laser burning/marking method B.1.

The stone material of the table top remains the same, but the pattern has been made by any of the production methods mentioned above.

Option 3

Mechanical milling/engraving/dressing/polishing method B.10 is used, so that given areas can be covered with say, gold leaf, as on old-time tombstones.

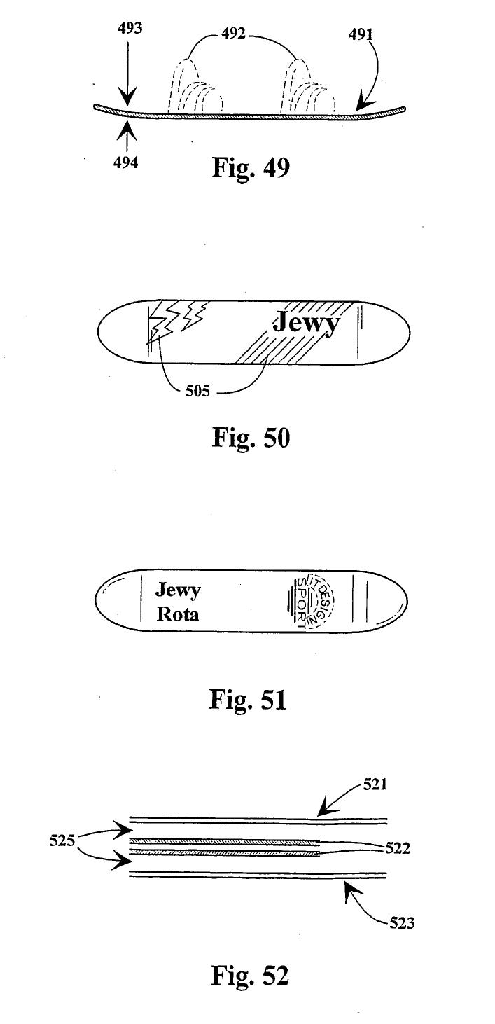

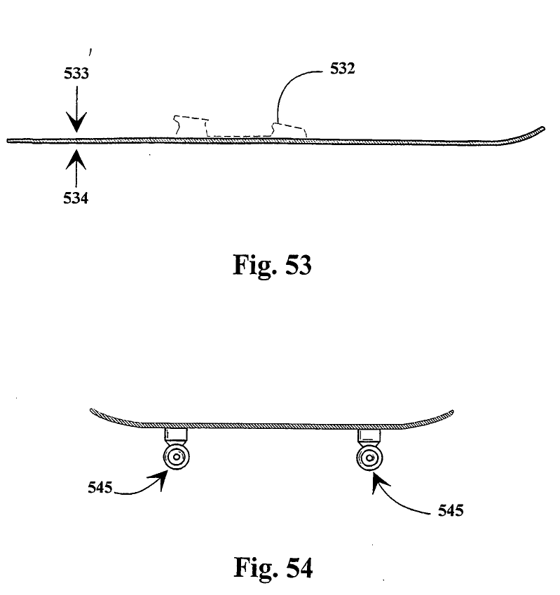

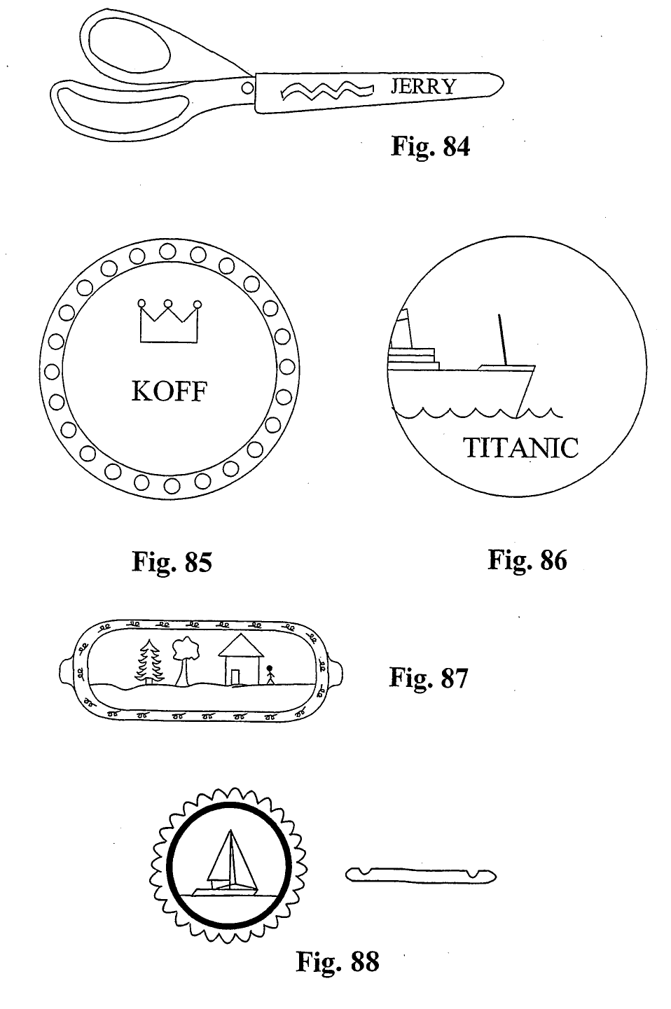

FIGS. 49-97 relate to the following groups a)-f) for the design and acquisition of the products mentioned below.

The product groups comprise, among other things:

a) Sports articles, such as:

snowboards

surfboards

windsurfers with sails

skateboards

skis

sportswear, such a tee shirts, peaked caps, knitted caps, sweat suits, shorts, towels, etc.

life jackets

floating jackets

ornamental patterns on guns, such as shotguns

b) Giftware and promotional items such as:

pencils, erasers, rules, calculators, pen casings, etc.

cigarette lighters

candles, candle lanterns, candlesticks

briefcases, bags

pocket flasks, shakers, carafes

bottle openers

key chains

c) Lamps, such as:

table, wall and ceiling lamps

spotlights

hand-held lamps

outdoor lamps, such as street, garden and park lamps

d) Clocks, such as:

watches, pocket watches

alarm and other bedside clocks

wall clocks

stopwatches

pulsometers

e) Tableware and related utensils, such as:

knives and forks

spoons

corkscrews

cheese slicers

knife sharpeners

scissors

cutting bases, pot, glass and bottle bases, trays

pots, oven moulds, bowls

containers and tins made of metal and ceramic

f) Musical instruments, such as

guitars

drums

amplifiers and loudspeaker casings

FIGS. 49-58 show part of products pertaining to product group a)

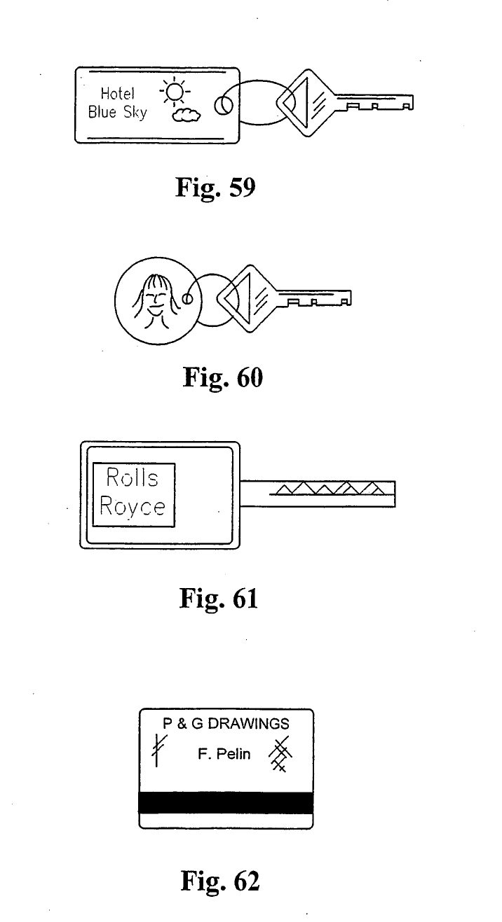

FIGS. 59-71 show part of products pertaining to product group b)

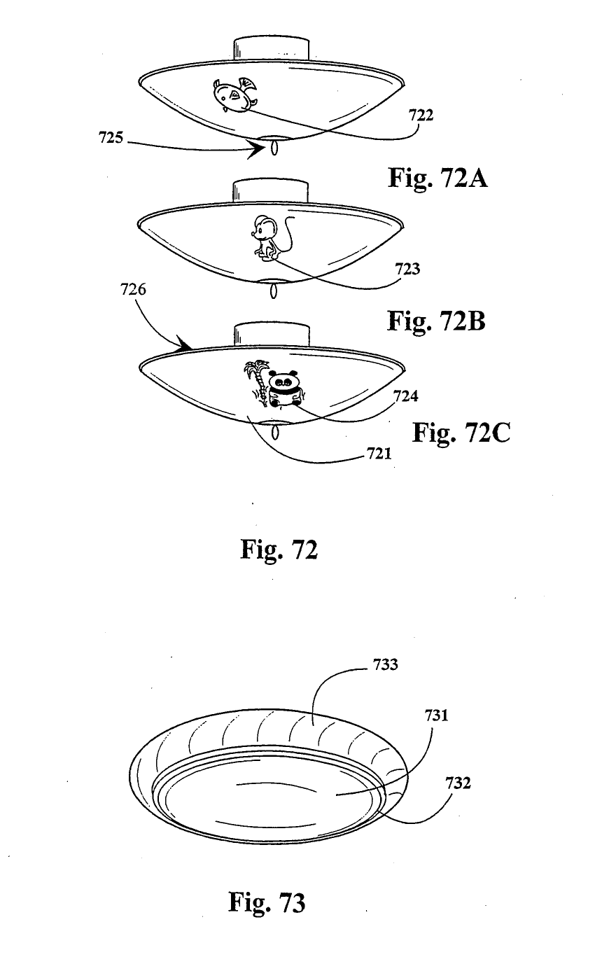

FIGS. 72-79 show part of products pertaining to product group c)

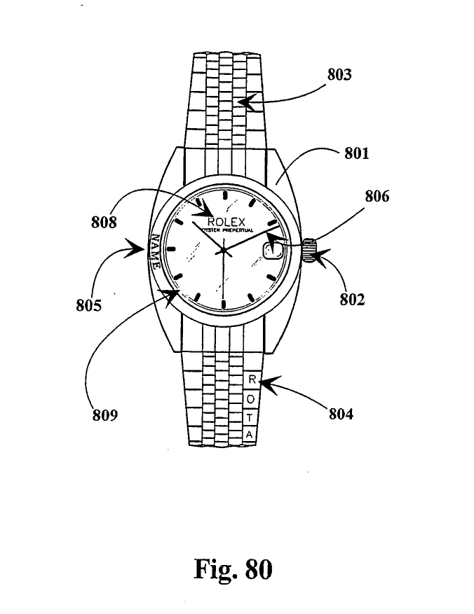

FIG. 80 shows one of the products pertaining to product group d)

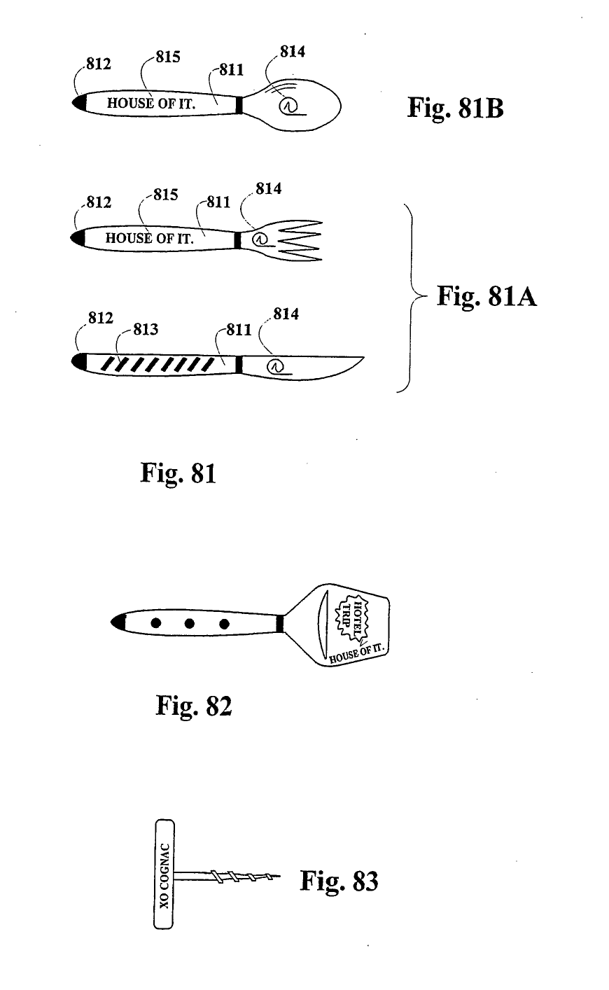

FIGS. 81-94 show part of products pertaining to product group e)

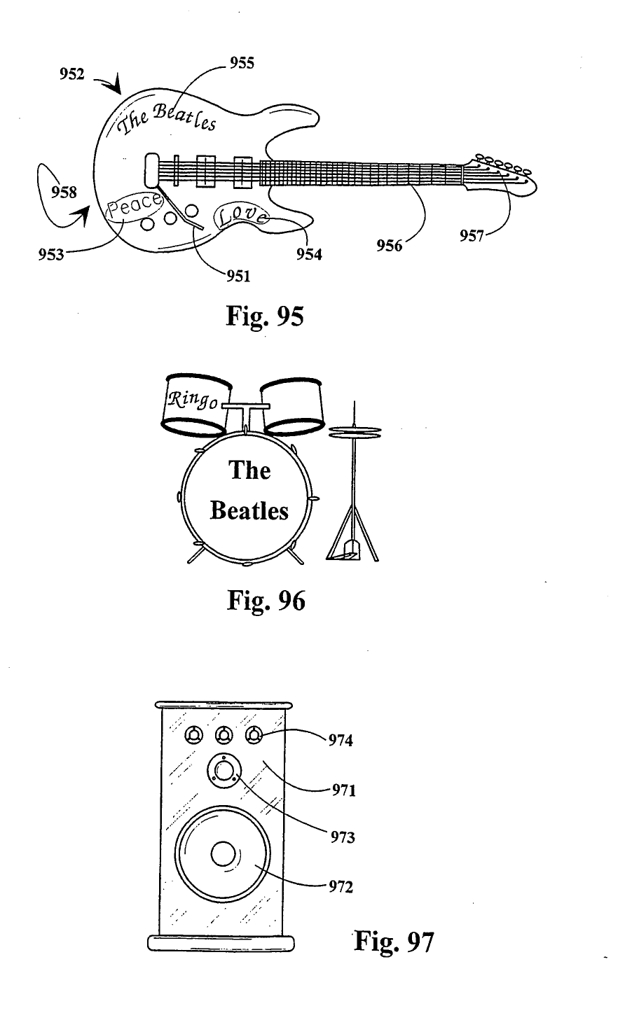

FIGS. 95-97 show part of products pertaining to product group f).

The production techniques comprise the following methods:

### Lamination

Lamination stands for jointing two materials or surfaces by glue, for instance, usually signifying that the two surfaces are otherwise ready before being joined.

### In-Mould Film

An in-mould film means that two materials or surfaces are joined at the die casting stage of plastic i.e. the two materials, the film proper and the dye casting components are made of plastic.

The in-mould film will be integrated in the product, which has usually been printed, metal-plated or otherwise prepared before deep drawing/processing, injection into the mould and die-casting (plastic products exclusively).

### Adhesive Film

An adhesive film is basically the same thing as an in-mould film, except that the images are transferred along with the film to the desired product, but the plastic film itself is removed. Between the image to be transferred and the actual plastic film, there is wax or any other release agent enhancing removal of the transferred image from the plastic film. Usually heat is required in the treatment of an adhesive film.

A. Coating Methods

1. Silver-plating (chemical metal coating, silver)

2. Vacuum evaporation (metal, gas, other substances)

3. Metal coating, chemical (glass+ceramic, burning)

4. Electro-catalytic coating (only of metals)

5. Ceramic coating (=glazing, enamelling)

6. Patination (chemical process).

B. Working Methods (Always in 2-Dimensional or 3-Dimensional Shape)

1. Laser processing/engraving

2. Hologram manufacturing techniques (real+others)

3. Laser printer techniques

5. Silk-screen printing techniques

6. Pneumatic/electrically operated spraying techniques

7. Piezoelectric spraying techniques

8. Offset and other printing techniques

9. Mechanical milling/engraving

10. Laser or water jet cutting.

C. Working Methods (Metal Processing)

1. Bevelling techniques

2. Punching/pressing techniques

3. Deep drawing/eccentric lathing

4. Other metal processing

5. Soldering, welding and other metal joining techniques

6. Pressure/free casting

7. Other known techniques.

D. Working Methods

1. Adhesive film, transfer of the image only

2. In-mould film, with the film integrated in the product along with the image

3. Lamination

4. Deep drawing/moulding (plastic).

E. Intermediate Working Steps

1. Process directed directly to the work piece

2. Process performed indirectly on the work piece e.g. by means of an adhesive film

3. A combination of the options above.

Product group a)

Snowboard, FIG. 49

The snowboard 491 may comprise a member, e.g. a clamp or a binding 492 on its upper surface. The texture or the image is placed on the upper surface 493, the lower surface 494 or even on both surfaces.

FIGS. 50 and 51. The customer may freely place the images 505 he desires both on the upper surface, FIG. 50, and the lower surface, FIG. 51.

FIG. 52. A typical design of a ski (downhill, cross-country, single) or a skateboard.

Usually a sandwich construction has been used, which comprises e.g. veneer or a honeycomb construction or a die-cast product, i.e. plastic, zone 522. The actual frame construction 522 is not altered, but only its visible surfaces, of which the upper outer surface 521 and lower outer surface 523 can be designed.

The proposed outer surfaces 521 and 523 are separate parts forming the visible outer portion of the product. The outer surfaces may be made of metal, plastic, veneer (wood-based) or any other material, e.g. glass fibre or other laminates.

Depending of the design selected by the customer, the program chooses one or more of production techniques A, B, C, D or E, thus achieving the desired end product.

### EXAMPLE

The customer chooses the snowboard type or creates the 3-dimensional shape himself. The frame construction 522 proper, FIG. 52, is veneer, for instance. The customer wishes to place images 525 on both sides of the snowboard (FIGS. 49, 51 and 52).

The outer surfaces 521 and 523, FIG. 52, may be made of different materials, since its outer surface 523 facing the ground must resist extremely heavy wear, consisting e.g. of a glass fibre laminate, whereas its upper outer surface 521, FIG. 52, may be made of transparent plastic, for instance. The outer surface 523 may, of course, be made of metal or plastic. In the exemplifying case, the outer surfaces are made of different materials and the processing methods are different.

Upper outer surface in FIG. 50. The customer has created a surface, for which he wishes, for instance, a glossy and reflective bottom area made of chromium metal, on which four-colour images 505 have been placed. Then the program chooses a transparent plastic film, e.g. polyamide having a 0.3 mm thickness, which receives a glossy chromium surface, and among the production techniques he chooses coating methods A, either silver plating; a silver nitrate that reacts with a reducing agent, so that the silver solution is precipitated on the film surface, or a vacuum evaporation method, by means of which e.g. chromium, zinc, silver or aluminium are brought into the surface of the plastic film (to the inner surface 505 of the outer surface in FIG. 52).

Subsequently, the desired image can be achieved, FIG. 52, outside the upper surface by any of working methods B 2-8, using laser-printing technique 3, for instance. Then the printed and metal-plated film can be cut to shape, e.g. using working methods V, 9 or 10. Since (FIG. 52), the lower surface is exposed to heavy wear, the program recommends e.g. a glass-fibre laminate or wear-resistant plastic (both being transparent), the printing being carried out with working methods V, 7, using a piezoelectric jet, which is placed either in a robot or on the x-y linear. If metal is used, FIG. 52, as the bottom coating, the image can be produced with working methods V, 1, laser processing/engraving on stainless steel. The exemplifying cases given above can be freely modified (with production techniques A, B, C, D and E). All that has been said above also applies directly to skis (downhill, cross-country, single) and to water skis and skateboards, for instance, which additionally have wheels 545, FIG. 54.

### Windsurfer and Surfboard

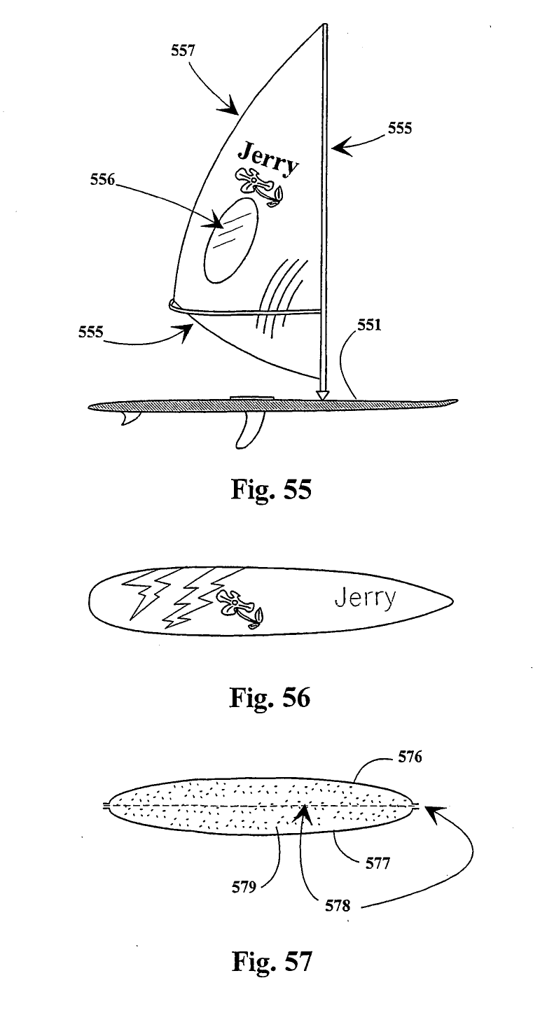

A windsurfer, FIG. 55, consists of the actual board 551, a mast and a horizontal clamp 555 and a sail 557. In principle, a windsurfer, FIGS. 55 and 56, has the same board design as a surfboard, and hence the construction of a surfboard will not be defined separately in the following, and the matter appears by studying the construction of a windsurfer.

A typical board design is shown in FIG. 57, where two plastic shell parts 576 and 577 have been joined generally be gluing at their joint 578, and the inner part 579 is typically filled with polyurethane or expanded polystyrene, which is light-weight and act as a float. Using the program, the sail 557 can be planned as follows. The dimensioning, shape and openings 556 and the pattern can be performed using working methods B, 2-8, intermediate work steps E and/or working method D by means of adhesive film 1. One can also cut parts, e.g. a window 556, in plastic (from which the sails are usually made), using working method B, laser or water jet cutting 10, and join them adequately, by gluing, sewing or ultrasound welding, for instance. The customer may also act on the material and colour of the mast and the horizontal clamp.

FIG. 56 shows the pattern of both the upper and the lower part, which can be carried out using working methods B, 2-8, and intermediate work step E.

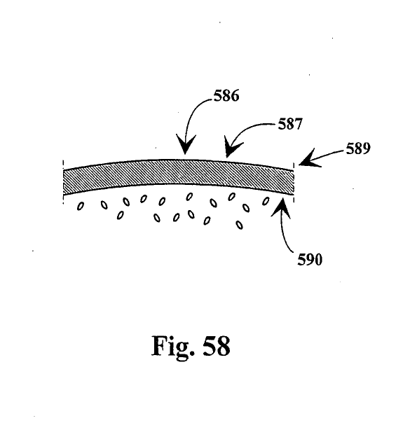

FIG. 58 shows a part of FIG. 57 in detail, where the pattern 586 and 587 can be applied both to the outer 589 and the inner surface 590. The pattern of the inner surface calls for a transparent body material. The pattern can also be made by in-mould film techniques if the product has been die-cast.

### Giftware and Promotional Items

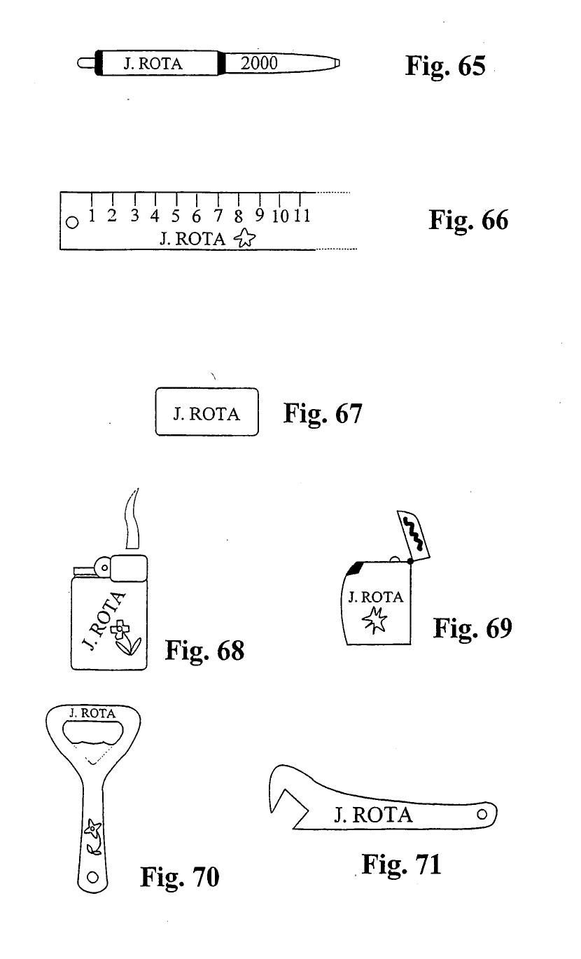

FIG. 65 shows a ballpoint pen of plastic, for instance, FIG. 66 a rule of plastic and FIG. 68 a disposable cigarette lighter of plastic.

The customer chooses the model, designs the appearance and places an order. If the customer wants a silver coating including a desired image or texture in four colours, the program chooses e.g. a silver surface, coating method A, vacuum evaporating method 2, and then the images are transferred to the product by means of an adhesive film.

FIG. 65 shows a metal ballpoint pen and FIG. 69 a metal cigarette lighter. The customer chooses the basic model of the product and the base metal of the product, copper, for instance. The customer wants the end surfaces of the product to be coated with real silver, the program chooses the coating method A electro-catalytic coating 5, silver, for instance.

The customer wishes to form the images of pure gold. Then the images can be formed with laser, increasing the material thickness at the image, or a silver surface can be protected at the areas where no image is wanted, using wax or varnish, for instance. This is followed by coating method A electro-catalytic process 4, in which the desired gold adheres to the surfaces devoid of protective wax, forming the desired image of gold.

The proceeding may also be different, i.e. forming first the coating of which the images will be made, coating method A electro-catalytic coating 4, of the gold of the entire product, e.g. in the region 4 of FIG. 69.

Then silver is coated on top using the same electro-catalytic method, and subsequently working method B, laser processing/engraving 1, is used to remove the silver from the surface for which the image 2 is intended, FIG. 69.

The measures above also apply to the products in FIG. 59-62 and 70, 71 and to production techniques A, B, C, D and E.

### Bags and Briefcases

The most frequently used bag materials are plastic, metal and leather, or a combination of these.

The program may act both on the outer surface of the bag and the interior 12 of the bag, FIG. 64.

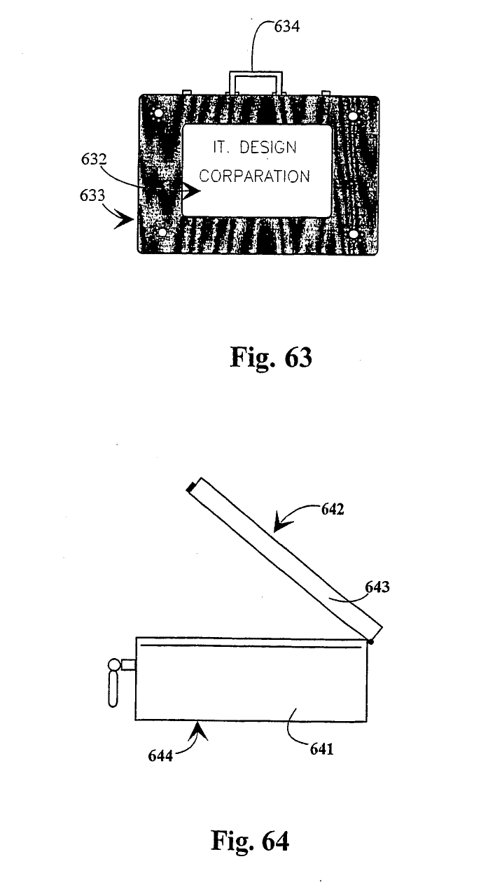

FIG. 63 shows a bag, in which a separate area 632 has been formed around the area 633, in which an image has been formed. The handle 634 and the latch have been fixed with metal fastenings, and the body of the bag may also be made of metal.

FIG. 64 shows a side view of the opened bag, with the short side 641 and the cover 642 and the cover side 643, such as the bottom 644, forming generally straight surfaces, which are easy to design.

All of the production techniques A, B, C, D and E mentioned above can be applied to this process. In other respects, the bag can be made quite normally using known methods, regardless of its material.

### Example 1

FIGS. 63 and 64 show a bag made of leather, in which the area 633 has different colour than area 632, in which the combination of image and name has been placed. First, the image can be printed in the usual way for leather, yet large areas are not usually died (printed) afterwards, but the leather is always died in its totality, and then it is cut to the desired shape.

Thus, the leather in area 633 is brown, for instance, and the central area 632 is black, with an image printed on it. The leather in area 633 is different leather than in area 632, the areas being joined by sewing and gluing at their joints. In addition, the customer has wanted a handle 634, and also the latch parts, rivets, corner protections and border made of metal. The customer chooses pure 24 carat gold. The program chooses the coating technique A 4, i.e. an electro-catalytic process and gold as the material. The leather can be mechanically cut, however, the working method B, laser or water jet cutting 10 is more efficient.

The image area 632 in FIG. 63 can also be formed using e.g. coating techniques B laser processing/engraving 1, removing the colour and forming a suede surface (coarse). This can also be used before the main dying operation, thus emphasising the text or the image, even with leather of the same colour.

### Example 2

The basic frame of a metal bag is e.g. aluminium or any other lightweight metal, titanium, for instance. The customer designs the appearance as follows:

All the surfaces of the bag in FIG. 63 are e.g. made of aluminium, the customer designs a shiny black area 633 by choosing ruthenium metal, a silver area 632 and a golden image in this.

First, the entire area 633 and 632 is coated using coating method A electro-catalytic coating 4, ruthenium metal, and since the area 633 should remain black, it receives a protecting wax or varnish coating, e.g. working method B 10, used for cutting a protective film, which covers the area 633, followed by waxing, e.g. B 6, using a jet, and after removal of the protective film the frame can be placed in an electrocatalytic basin A 4, where gold plating is performed. The area 632 has now gilded, and when the same area is silver-plated, the product is removed from the basin.

Then the image/texture of area 632 in FIG. 63 shall be formed, which is easily done using coating method B laser processing engraving 1, with which the silver surface is removed by carving to make the gold appear.

The same processes may naturally be performed on all the surfaces of FIG. 64, points 641, 642, 643 and 644.

### Example 3

The bag is made of die-cast plastic+in-mould film. As in the preceding examples, FIG. 63, area 633 is dark and the central area 632 is bright with a gilded texture/image.

First, the actual in-mould film is wound/transferred for printing, e.g. working method B laser printing unit 3, where an adhesive film having exactly the appearance designed by the customer is printed. In the following step, the film is subjected to deep drawing/shaping to the adequate shape, e.g. typically almost or exactly to the final 3-dimensional format. Next it is tranferred to a die casting mould, the mould is closed and die-casting may be started. At the end of 50 s., for instance, a product or product part has thus been obtained, e.g. a bag cover, having an adhesive film with the appearance designed by the customer die cast to the plastic part, and the product is completed.

### Giftware and Promotional Items Such as Key Chains and Similar Products

FIG. 59 shows a key chain made of metal, for instance, for which the customer first designs the 2-dimensional/3-dimensional shape, and then the appearance of the body. The production process is the same as for a ballpoint pen made of metal, for instance.

FIG. 60 shows a key chain made of plastic, in which the production process based on an in-mould film is used.

FIG. 61 shows a car key. The process is the same as in FIG. 60, but die-casting takes place directly on the key body/shaft, or then is the same as in FIG. 59, for instance.

FIG. 62 shows an electric key, a magnetic tape, a chip, a punch card key or a similar key, identifier or ID card suitable for non-mechanical encoding.

### Giftware and Promotional Items Such as Candles, Candle Bases and Candleholders

Candles are known to be of any colour or to have an outer surface of any colour. Colour pigments and colouring agents are known.

The customer designs the appearance of the candle. Working method B colour/ink jet printing 4 is suitable on top of an adhesive film D, 1.

### Lamps

FIG. 72 shows ceiling lamps (FIGS. 72A, 72B and 72C), FIG. 73 a ceiling lamp, 74 a fabric-coated ceiling lamp and an etched floor lamp and ceiling lamp.

The base material of the ceiling lamp in FIG. 72 is transparent glass 721, for which the customer designs the shape, e.g. images 722, 723 and 724, designs the shapes 725 of the fastening members and the shape of the frame 726.

In the most straightforward embodiment, quite ordinary UV or thermally cured printing colours may be used to achieve the images 722, 723, 724 and the frame 726, e.g. using working method D adhesive film 1, which may be printed with working method B, 3-8, any method of these, or directed straight to t in work steps E, 1.

If a high quality product is desired, “glass burning colours” should be used, i.e. glazing that needs to be baked in an oven at a minimum temperature of +350° C. i.e. typical ceramic coating materials.

Then the same work process as above can be used, with the colouring agents of different colours, cf. coating method A, ceramic coating 5.

The customer may choose as coating for the holder part 725 in FIG. 72 any metal, silver for instance. Then the holder member 725, of copper, for instance, is coated by electro-catalytic means A 4.

The central part of the ceiling lamp in FIG. 73 is transparent 731 and its outer edge is made of bright compressed glass 733, and the parts are joined by a brass frame 732, which has been coated by electro-catalytic means.

The example above serves to show that the customer may design different appearance even if the 3-dimensional format remains the same, the customermay, for instance, design the appearance with the central part 731 made of bright acid-treated glass and the outer edge 733 transparent blue, the two parts joined by a brass frame, which has been enamelled green. There may be hundreds of variants without the printing in FIG. 72.

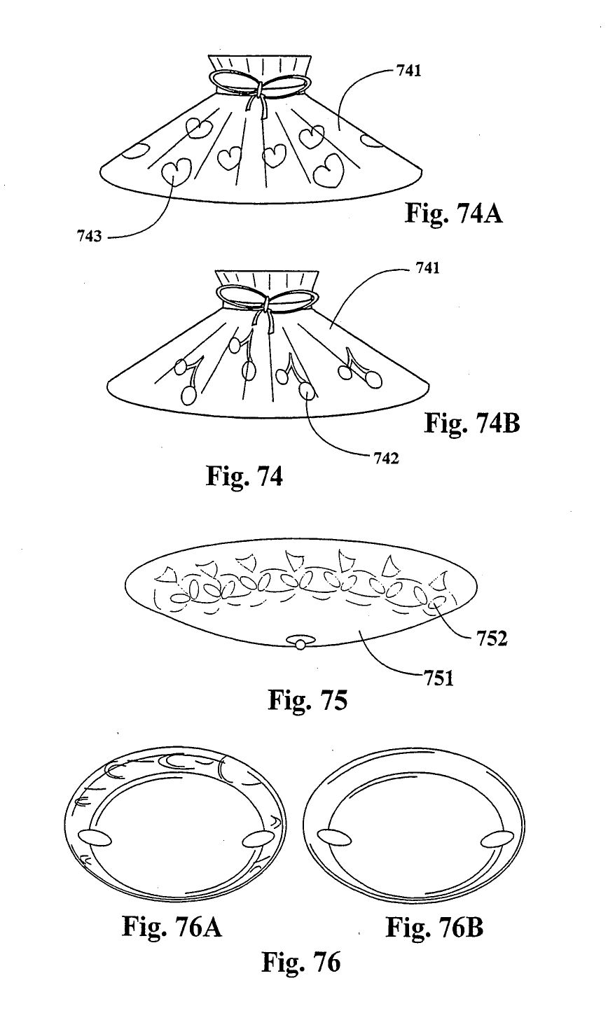

FIG. 74 shows a ceiling lamp made of fabric (FIGS. 74A and 74B), of which the customer has designed the appearance, the colour 741 and the images 742, 743.

FIG. 75 shows a ceiling lamp, in which patterns 752 have been made in glass 1 by mechanical acid treatment, i.e. etching, which etches the surface.

Patterns can be produced also with working method B laser processing/engraving 1 or etching, ink balls, silkscreen B, 5 or 8, or B, 4 or 7, attached to a robot arm. Adhesive film may still be the most advantageous way of performing etching on glass.

### Lamps, Such as Street, Outdoor, Wall, Park and Garden Lamps

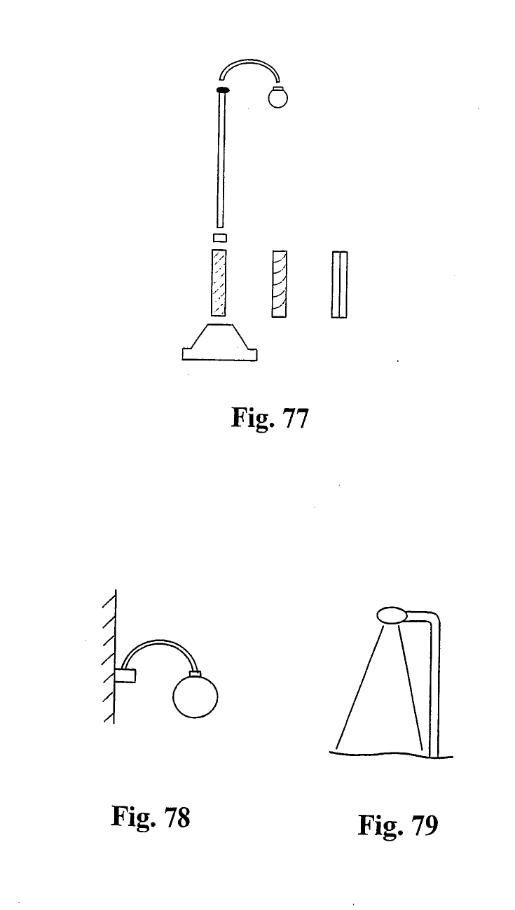

FIGS. 77 and 78

The customer designs the appearance by choosing e.g. among group A-F the finished basic elements, dimensioning the lengths, choosing the lamp type, and then proceeding to the further processing operations.

The customer picks the parts, A, B, C, D and E he wants, e.g. made of black steel, and designs the shapes with the surface of parts A, B, C, D made of copper and part E, the lamp member, made of gold and the lamp shade of greenish glass.

Then the program chooses the correct work process A coating methods, electrocatalytic process 4, in which, using the process mentioned first, parts A-D are subjected to a work process, where the surface is coated with zinc, for instance, to prevent corrosion. Then the same work process is performed and a nickel layer is obtained, after which the finished surface is prepared with the same work process, copper, and finally working method B laser processing/engraving 1 is used for forming the images planned by the customer.

1. Choose or design the appearance of the lamp or the lamppost, model A, B, C, D, E or F.

2. Choose the raw material

black steel/iron/cast iron

acid-proof/stainless steel

copper/brass/bronze

aluminium

any other material or alloy

3. The program chooses and designs the surface

an electro-catalytic process, coating, copper, zinc, gold, silver, ruthenium etc.

electrolytic oxidation processes on aluminium

painting

aqua graphics

other

4. Choose and design the surface pattern

laser

### Watches

There are many kinds and types of wristwatches, precious (brand) watches, containing real gold or other precious metals, and simple but yet sophistticated watches e.g. Swatch, and a plethora of different watchstraps or chains.

In the following we shall describe two extreme examples, a precious watch of Rolex type and a modern watch of Swatch type.

### Example 1

A Rolex type watch, FIG. 80, whose aspect the customer has designed as follows, for instance:

The actual watch body 801, made of steel, shall have a coating of 18-carat high gloss white gold. The program chooses the correct process for white-gold plating; a pre-treatment with catalytic polish, electro-catalytic nickel-plating, electro-catalytic copper plating and last electro-catalytic silver deposit. cf. coating methods A, electro-catalytic coating 4. Then one can proceed to finishing coating treatment, e.g. white gold plating, using said electro-catalytic method A, 4.

The customer designs the appearance of the button 802, equipped e.g. with a reddish gold plating or a rhodium gold alloy. Then process is the same as described above, however, with a finish of rhodium gold alloy, i.e. with the final coating made of rhodium gold.

Next the customer designs the shape of the actual wrist strap 803, e.g. with gold in the central part and platinum in the outer parts.

The frame 805 of the watch dial is usually an ornamental part, which is also connected to the attachment of a glass 809 to the actual body 801. The customer plans its appearance, made of gold, for instance, and the process continues as above.

The customer may also have designed the appearance of the parts above, the frame 801, the chain 803 and the frame 805 with their images and texts made of silver.

The program makes decisions on the basis of the customer's design without the customer having necessarily to know the technical processes or order it should thus be noted that there is a silver layer under the gold surface. In technical terms and regarding the appearance this silver layer would not be necessary, but since the customer had designed the appearance of the product definitely, designing the images 4 in silver, the program decided to place a silver layer under the final gold layer.

Consequently, the production of the images designed by the customer in silver is extremely efficient and has high quality, using working methods B, laser processing/engraving 1.

The uppermost gold layer is removed by “craving” with laser at the necessary locations, so that the images with the appearance designed by the customer are obtained, e.g. 804 text/name Rota, frame 804 first name, e.g. Jerry.

Hence the customer takes no standpoint to the technical process or to decision-making, but designs the appearance of the product with the liberties and restrictions of the program.

Thus a completely individual product can be created exactly as the customer has designed it.

The rear part of the watch body can be subjected to the same operations, and what is more, also the inside. This means that it is not worthwhile stealing this particular product, because it carries somebody's identification data, and people hardly want to use a product containing the picture/data of a stranger.

Any picture or text can be engraved in the glass 809 itself.

### Example 2

A swatch type watch, which may, of course, be made of metal as in example 1, but may also be made throughout of plastic, can still be designed by the customer in any way, in the exemplifying case all the parts are made by in-mould film technique.

This allows the creation of any surface, photographs, texts, metal-plated surface, hologram, etc.

The customer designs the appearance and the program selects the production techniques.

Thus, for instance, an in-mould film may be printed using working method B, e.g. laser printing technique 3, then be deep drawn and shaped, transferred into a mould and the product can be die cast.

By the same token, other products can be designed, such as alarm clocks, wall clocks, stopwatches, pulsometers, and electronic devices such as portable CD recorders, compasses, cameras and video cameras.

### Tableware

The work process of the knives in FIG. 81, the forks in FIG. 81A, the spoons in FIG. 81B and the cheese slicer in FIG. 82, which usually are made of stainless steel or silver, is exactly the same as that of say, metal watches, except that these do not comprise any glass.

The stainless steel body RST of the exemplified products and the end of the products is glossy black 822, on which an ornamental black glossy area 813 has been formed, on which a logo 814, a name and say, the name of a house 815, “House of . . . ” have been placed. The customer has designed the aspect and images for the black area and selected ruthenium metal.

The program selects the work process. First the entire product is embedded in wax or varnish, and using e.g. working method B, the varnish/wax is removed from the desired areas by means of laser 1. In the electro-catalytic process, the coating adheres to the areas of the product from which laser B, 1 has removed the protective wax/varnish by burning/engraving.

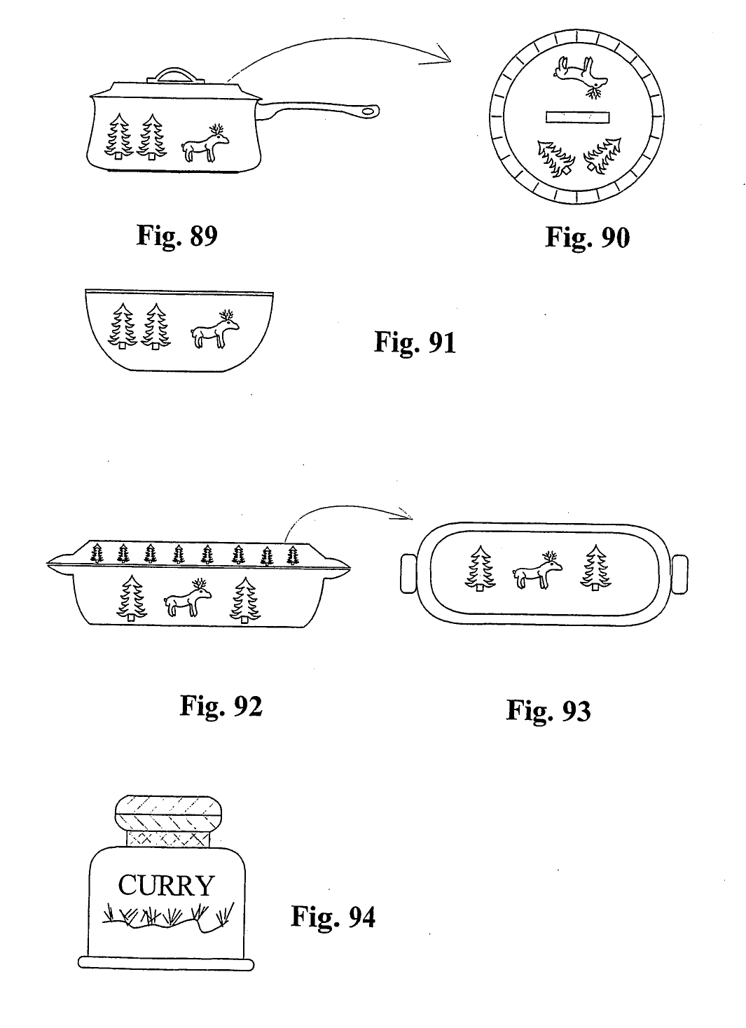

Laser may naturally burn the images directly on metal. Scissors and the pots of figure 89 can be designed in the same way as the products mentioned above.

### Dishes

The glass bowl of FIG. 91, a salad bowl, for instance, can be designed for etching with various types of acids or other chemical substances. This method has been long used as an industrial chemical process. The customer designs the appearance of the product and the program chooses the production techniques.

Thus, for instance, the surface of the bowl 911 can first be protected with wax, varnish or any other protective substance, and the protective layer can then be removed from the desired areas by means of laser processing/engraving.

In the actual work process, the chemical reaction with glass occurs only on the areas not covered with protective coating.

The process may also be performed with an adhesive film, either by transferring the protective coating from the film to the actual product, followed by the work process described above, or by applying the active chemical substance to the outer surface of the product, or any combination of these. The adhesive film is printed using working methods B, 3, 4, 7, for instance. Other “printing methods” can also be applied directly to the product, such as ink ball printing, silk-screen printing, piezo-electric jet, placed in a robot.

### Guitar and Musical Instruments

The frame material of the guitar 952 in FIG. 95, an electric guitar, for instance, is wood, and it is usually made of glued wooden battens or boards to prevent twisting, or of MDF or the like. Various types of plastic are also usable.

The program may act on the 3-dimensional shape of the guitar, in other words, the shape and the size are freely chosen. After the basic frame has been formed, the final shape can be readily milled by mechanical means, using a form-cutting tool, on the basis of the file compiled by the customer.

The customer selects the type and number of microphones, selects and designs the neck 956 and the tongue tensioners 957. The customer is free to from the images 953, 954, 955 at the locations he wishes, also on the rear side 958 of the guitar, and to plan the position of the other components as well, a vibra 951, for instance.

The design described above can be performed using coating methods A, 1 and 2, working method B, all of 1-10, working methods D and intermediate work steps F.

### Example 1

The customer wants a plain guitar frame 952 and selects the one he wants in the colouring system, or creates a shade of his own; then coating takes place with working method B, pneumatic/electric jet 6.

If the customer wants images 953, 954 and 955, he may order separate images and glue them on his guitar (FIG. 95). For higher reflectance, the frame 952 should first be coated with primer varnish, followed by selection of 1 or 2 of coating methods A, thus achieving a highly light reflective metal surface. The customer may tone off the shade he wishes, however, in this case, using varnish (or transparent colour) and working method B, 6, in order to coat the entire frame. The texture and images 953, 954 and 955 can also be coated directly using e.g. working method B, 6 and/or 7, intermediate work step E, 1, a robot for instance, or tools 6 or 7 attached to the x, y linear.

The images can also be produced by means of adhesive film.

### Example 2

Since a guitar is seldom die cast from plastic, an in-mould film proper cannot be used, except when a sufficient amount of binder has been mixed with MDF to adhere to the in-mould film. In that case, an in-mould film can be used at the MDF pressing stage.

The frame is most frequently first milled to the desired shape, and only then follows the actual coating process.

### Example 3

The plastic film used in the example, on which the image and texture are placed, has been deep drawn or otherwise brought to the desired shape, and laminated on the guitar frame using glue, for instance. Thus, all the work processes can be carried out while the film is still in a smooth state, in other words, one can use coating methods achieving extremely high contrast and colour repetition, working method B, laser printing technique 3. This image has been covered with metal plating, silver plating 1 or vacuum evaporation method 2.

FIG. 96 illustrates a set of drums, for which the customer selects the desired parts supplied by the manufacturer of his choice.

The loudspeaker in FIG. 97 is a good example of a design product, for which the design and material choice over the Internet is very useful, given the myriad of manufacturers of loudspeaker elements, bass 972, mid range 973 and descant 974. In this conjunction, the points of attachment, the screw locations and the necessary perforations in the front part of the housing 971 vary from one case to another.

Consequently, the customer selects the loudspeaker types and the program indicates say, the appropriate distribution filter and the minimum size of the housing itself. The customer designs the appearance of the loudspeaker housing or selects a ready-made housing, chooses the loudspeakers and designs their appearance

This yields the benefit of the manufacturer not having to keep products in store, since manufacture is not started until the customer has placed an order.

Design and orders over the Internet bring a solution to logistic and storage problems, since manufacture is started only after an order has been received.

In the examples above, the Internet has been used, however, other interfaces presently known or taken into use in the future can obviously be used as well.

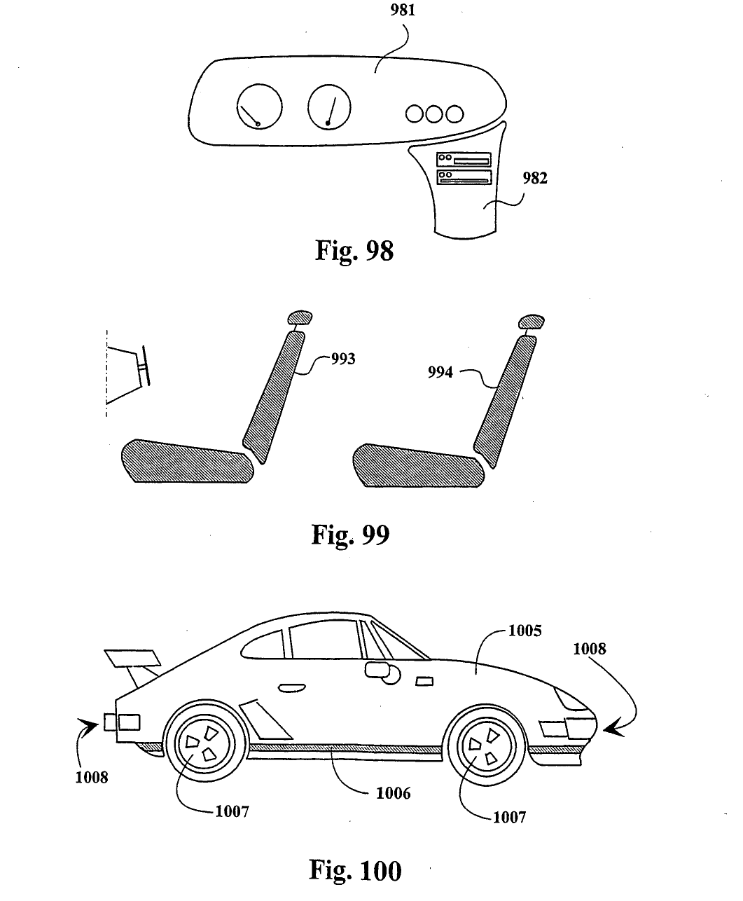

FIGS. 98, 99 and 100 relate to the last example, which exemplifies a car and the related design and acquisition.

FIG. 98 shows the dashboard of a car,

FIG. 99 shows car seats and

FIG. 100 shows a car.

The customer designs both parts pertaining to the car interior and to the outer casing using the Internet program. The material of the dashboard 981, 982 may be metal, plastic or even pure wood. The coating may be selected among the production techniques mentioned above. The upholstery of the seats 993, 994 can be picked from a large fabric range or from leather selections and qualities of different colours. The car colour 1005 can be selected from a wide colour chart, which also includes metal and nacreous colour surfaces. The lateral strips 1006 and their colours can be freely chosen. The tyre rims 1007 can be selected from a wide range and their coating among the production techniques mentioned above. The car buffers 1008 may be either chosen from a selection or even designed by the customer himself within given limits. Although the car engine is not included in the design, it is indeed possible to choose a petrol or diesel engine with the desired power.

In the examples above, the Internet has been used, however, other interfaces presently known or taken into use in the future can obviously be used as well.

The two method variants A and B are suitable as such for the design of large logos, images and other graphics using the customer's computer and the display of a mobile phone.

The customer may compose either still pictures or moving pictures (graphics).

The images are loaded down in the customer's mobile phone either directly from his computer using an adequate device, or with the customer transmitting it via an operator, such as Radiolinja, to his own mobile phone in the form of a picture message, SMS, etc.

Products/Product Segments

1. Puzzles

2. Postcards

3. Schoolbooks (educational literature)

4. Clothing, such as tee shirts, peaked caps, etc.

5. Carpets, wall-to-wall carpets

6. Electric appliances, such as plug sockets/plugs and switches

7. Electric and water radiator heaters

8. Sports equipment, such as golf equipment

9. Umbrellas

It is obvious to those skilled in the art that the invention is not confined to the examples above, but may vary within the scope of the claims.

1. A method for acquiring a given product over a public network such as the Internet, whereby the customer has the opportunity to influence with his computer the appearance of the product, such as the surface pattern, colour, text, logos, pictures etc., and after this the customer orders the product he has designed from the manufacturing company, characterised in that the customer acquires an application program for the design of the product and contacts the product and service provider, selects the product he desires and designs the appearance of the product using his own computer.

2. A method as defined in claim 1, characterised in that the application program comprises a fixed data transmission system, including, among other things:
teaching programs
design programs
graphic control programs
picture processing and editing programs
material files
letters and numbers
fonts and special signs.

3. A method as defined in claim 1, characterised in that the product data program, which is a variable data transmission system, includes among other things:
company data
instructions of use
3-dimensional shape of the product
product data
control data and a code indicating the programs in use
billing and delivery information.

4. A method as defined in claim 1, characterised in that the customer controls by, means of his own computer and without any program of his own, the computer of the product and service provider.

5. A method as defined in claim 1, characterised in that the customer is in permanent connection with the product and service provider during the design process over a broadband network, for instance.

6. A method as defined in claim 1, characterised in that the customer is in connection with the product and service provider via a modem and in that the design program is part of an application program.

7. A method as defined in claim 1, characterised in that the application program is divided into at least two parts.

8. A method as defined in claim 7, characterised in that the customer acquires the first part of the application program from the Internet or a shop in CD, DVD etc. form.

9. A method as defined in claim 8, characterised in that the application is divided into two parts with the first part comprising the following programs, among other things:
data packing programs
picture processing and editing programs
graphic programs
design programs
teaching programs
letters and numbers
fonts and special signs
and in that the second part includes the following programs, among other things:
company data
3-dimensional geometry, i.e. the shape of the product
prices
other variable product information.

10. A method as defined in claim 7, characterised in that the second program additionally comprises a control program, which opens/gives access to the correct programs and files in the first part of the application program, which the customer has acquired in a separate process.

11. A method as defined in claim 7, characterised in that the customer himself designs the first part of the application program to meet his individual design requirements.

12. A method as defined in claim 7, characterised in that the product and service provider designs the application program in conformity with his market segment.

13. A method as defined in claim 1, characterised in that the functions are controlled over a keyboard.

14. A method as defined in claim 1, characterised in that the functions are controlled using a text.

15. A method as defined in claim 1, characterised in that the functions are controlled by sound.
